(19) United States
(12) Patent Application Publication
(10) Pub. No.: US 2026/0136381 A1
(43) Pub. Date: May 14, 2026

(54) METHOD AND APPARATUS FOR TRANSMITTING AND RECEIVING SIGNAL IN COMMUNICATION SYSTEM

(71) Applicant: Electronics and Telecommunications Research Institute, Daejeon (KR)

(72) Inventors: Jung Sun UM, Daejeon (KR); Jae Hyun SEO, Daejeon (KR); Sung Ik PARK, Daejeon (KR)

(73) Assignee: Electronics and Telecommunications Research Institute, Daejeon (KR)

(21) Appl. No.: 19/382,793

(22) Filed: Nov. 7, 2025

(30) Foreign Application Priority Data
Nov. 8, 2024 (KR) 10-2024-0158371
Feb. 4, 2025 (KR) 10-2025-0013972
Mar. 18, 2025 (KR) 10-2025-0034733
Mar. 27, 2025 (KR) 10-2025-0039826
May 9, 2025 (KR) 10-2025-0060230
Nov. 6, 2025 (KR) 10-2025-0166650

(51) Int. Cl. H04W 72/40; H04L 5/00

(52) U.S. Cl. CPC H04W 72/40; H04L 5/0007

(57) ABSTRACT

A method of a first communication node may comprise: generating a first preamble including a first part indicating a start of a first signal and a second part for clock acquisition; generating a physical reader-to-device channel (PRDCH) including data; and transmitting, to a second communication node, the first signal including the first preamble and the PRDCH.

### CROSS-REFERENCE TO RELATED APPLICATIONS

This application claims priority to Korean Patent Applications No. 10-2024-0158371, filed on Nov. 8, 2024, No. 10-2025-0013972, filed on Feb. 4, 2025, No. 10-2025-0034733, filed on Mar. 18, 2025, No. 10-2025-0039826, filed on Mar. 27, 2025, No. 10-2025-0060230, filed on May 9, 2025, and No. 10-2025-0166650, filed on Nov. 6, 2025, with the Korean Intellectual Property Office (KIPO), the entire contents of which are hereby incorporated by reference.

### BACKGROUND

### 1. Technical Field

The present disclosure relates to a signal transmission and reception technique in a communication system, and more particularly, to a technique for transmitting and receiving signals in a communication system which enables Internet of Things (IoT) devices to operate with low power.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In information and communication technologies, the Internet of Things (IoT) has recently attracted significant attention due to its ability to improve industrial production efficiency and enhance comfort in daily life. In IoT technology, IoT devices may operate with low power. To this end, the IoT devices and a wireless device that provide wireless signals to the IoT devices may require procedures for transmitting and receiving signals with each other.

### SUMMARY

The present disclosure for resolving the above-described problems is directed to providing methods and apparatuses for transmitting and receiving signals in a communication system which enables Internet of Things (IoT) devices to operate with low power.

A signal transceiving method in a communication system according to a first exemplary embodiment of the present disclosure, performed by a first communication node, may comprise: generating a first preamble including a first part indicating a start of a first signal and a second part for clock acquisition; generating a physical reader-to-device channel (PRDCH) including data; and transmitting, to a second communication node, the first signal including the first preamble and the PRDCH.

The step of generating the PRDCH including the data comprises: performing line encoding on the data; and mapping a result of the line encoding to orthogonal frequency division multiplexing (OFDM) symbols to generate the PRDCH.

The first part includes a first indicator having at least one first voltage signal and at least one second voltage signal in at least one OFDM symbol duration, and the first indicator indicates the start of the first signal.

The second part comprises at least one first clock-acquisition signal having a first voltage level and at least one second clock-acquisition signal having a second voltage level, and the first clock-acquisition signal and the second clock-acquisition signal are alternately arranged.

The PRDCH comprises at least one first PRDCH signal having a first voltage level and at least one second PRDCH signal having a second voltage level, and the second part includes an indication pattern for providing information on a first transmission time of the first PRDCH signal or information on a second transmission time of the second PRDCH signal.

The indication pattern comprises at least one first clock-acquisition signal having the first voltage level and at least one second clock-acquisition signal having the second voltage level, and a third transmission time of the first clock-acquisition signal or a fourth transmission time of the second clock-acquisition signal is the same as the first transmission time or corresponds to the first transmission time.

The indication pattern comprises a plurality of on-off keying (OOK) symbols, and an interval between rising edges or an interval between falling edges of the plurality of on-off keying symbols indicates the first transmission time or the second transmission time.

The indication pattern is a base pattern formed of at least one first on-off keying (OOK) symbol and at least one second on-off keying (OOK) symbol, and a repetition count of the base pattern indicates the number of single-bit chips of the PRDCH.

The second part includes a second indicator comprising at least one of a first on-off keying (OOK) symbol and a second on-off keying (OOK) symbol, and the second indicator indicates an end of the second part.

The PRDCH further includes control information of a second signal, and the control information of the second signal comprises at least one of information on a period of a midamble or information on an additional midamble inserted into a last part of the second signal.

The period is indicated in units of bits and is determined according to a chip duration of the second signal.

The method may further comprise: receiving, from the second communication node, the second signal formed based on control information of the second signal.

A signal transceiving method in a communication system according to a second exemplary embodiment of the present disclosure, performed by a second communication node, may comprise: receiving, from a first communication node, a first signal including a preamble comprising a first part indicating a start of the first signal and a second part for clock acquisition, and a physical reader-to-device channel (PRDCH) providing control information and data of a second signal; obtaining the control information and the data of the second signal from the PRDCH; generating the second signal based on the control information of the second signal; and transmitting the second signal to the first communication node.

The second part includes at least one first clock acquisition signal having a first voltage level and at least one second clock acquisition signal having a second voltage level, wherein the PRDCH includes at least one first PRDCH signal having the first voltage level and at least one second PRDCH signal having the second voltage level, and wherein a first transmission time of the first clock acquisition signal or a second transmission time of the second clock acquisition signal is identical to a third transmission time of the first PRDCH signal or a fourth transmission time of the second PRDCH signal.

The control information for the second signal includes information on a chip duration of the second signal, and the step of generating the second signal based on the control information of the second signal comprises: determining the chip duration from the control information of the second signal; and generating the second signal based on the chip duration.

The control information of the second signal includes information on a chip duration of the second signal, and the generating of the second signal comprises: determining the chip duration from the control information of the second signal; and generating the second signal based on the chip duration.

The period is indicated in units of bits, and a position of the midamble is determined according to the period and a chip duration of the second signal.

A signal transceiving apparatus in a communication system according to a third exemplary embodiment of the present disclosure, implemented as a first communication node, may comprise at least one processor, wherein the at least one processor may cause the first communication node to perform: generating a first preamble including a first part indicating a start of a first signal and a second part for clock acquisition; generating a physical reader-to-device channel (PRDCH) including data; and transmitting, to a second communication node, the first signal including the first preamble and the PRDCH.

In the generating of the PRDCH including data, the at least one processor causes the first communication node to perform: performing line encoding on the data; and mapping a result of the line encoding to orthogonal frequency division multiplexing (OFDM) symbols to generate the PRDCH.

The second part includes at least one first clock acquisition signal having a first voltage level and at least one second clock acquisition signal having a second voltage level, wherein the PRDCH includes at least one first PRDCH signal having the first voltage level and at least one second PRDCH signal having the second voltage level, and wherein a first transmission time of the first clock acquisition signal or a second transmission time of the second clock acquisition signal is identical to a third transmission time of the first PRDCH signal or a fourth transmission time of the second PRDCH signal.

According to the present disclosure, a wireless device can modulate data or bits using an on-off keying (OOK) scheme in consideration of an IoT device operating with low power. The wireless device can transmit the data or bits modulated by the on-off keying scheme to the IoT device. The IoT device can receive the data or bits modulated by the on-off keying scheme from the wireless device. The IoT device can operate with low power by receiving the data or bits modulated by the on-off keying scheme from the wireless device.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a communication system including IoT devices.

FIG. 4 is a conceptual diagram illustrating exemplary embodiments of a signal transmitted from an R node to a D node.

FIG. 5 is a conceptual diagram illustrating exemplary embodiments of a method for configuring OOK symbols in an orthogonal frequency division multiplexing (OFDM) symbol duration.

FIG. 6 is a conceptual diagram illustrating exemplary embodiments of a method for configuring a start indicator part.

FIG. 7 is a conceptual diagram illustrating exemplary embodiments of a method for configuring a start indicator part.

FIG. 8 is a conceptual diagram illustrating exemplary embodiments of a method for configuring a start indicator part.

FIG. 9 is a conceptual diagram illustrating exemplary embodiments of a method for configuring a start indicator part.

FIG. 10 is a conceptual diagram illustrating exemplary embodiments of a method for configuring a start indicator part.

FIG. 11 is a conceptual diagram illustrating exemplary embodiments of a method for configuring a start indicator part.

FIG. 12 is a conceptual diagram illustrating exemplary embodiments of a method for configuring a start indicator part.

FIG. 13 is a conceptual diagram illustrating exemplary embodiments of a method for configuring a start indicator part.

FIG. 14 is a conceptual diagram illustrating exemplary embodiments of a method for configuring a start indicator part.

FIG. 15 is a conceptual diagram illustrating exemplary embodiments of a method for configuring a clock acquisition part.

FIG. 16 is a conceptual diagram illustrating exemplary embodiments of a method for configuring a clock acquisition part.

FIG. 17 is a conceptual diagram illustrating exemplary embodiments of a method for configuring a clock acquisition part.

FIG. 18 is a conceptual diagram illustrating exemplary embodiments of a method for configuring a clock acquisition part.

FIG. 19 is a conceptual diagram illustrating exemplary embodiments of a method for configuring a clock acquisition part.

FIG. 20 is a conceptual diagram illustrating exemplary embodiments of a method for configuring a clock acquisition part.

FIG. 21 is a conceptual diagram illustrating exemplary embodiments of a method for configuring a clock acquisition part.

FIG. 22 is a conceptual diagram illustrating exemplary embodiments of a method for configuring a clock acquisition part.

FIG. 23 is a conceptual diagram illustrating exemplary embodiments of a method for configuring a clock acquisition part.

FIG. 24 is a conceptual diagram illustrating exemplary embodiments of a method for configuring a clock acquisition part.

FIG. 25 is a conceptual diagram illustrating exemplary embodiments of a method for configuring a clock acquisition part.

FIG. 26 is a conceptual diagram illustrating exemplary embodiments of a method for configuring a basic pattern for clock acquisition.

FIG. 27 is a conceptual diagram illustrating exemplary embodiments of a method for configuring a basic pattern for clock acquisition.

FIG. 28 is a conceptual diagram illustrating exemplary embodiments of a method for configuring a clock acquisition part.

FIG. 29 is a conceptual diagram illustrating exemplary embodiments of a method for configuring a clock acquisition part.

FIG. 30 is a conceptual diagram illustrating exemplary embodiments of a method for configuring a clock acquisition part.

FIG. 31 is a conceptual diagram illustrating exemplary embodiments of a method for configuring a clock acquisition part.

FIG. 32 is a conceptual diagram illustrating exemplary embodiments of a method for configuring a clock acquisition part.

FIG. 33 is a conceptual diagram illustrating exemplary embodiments of a signal transmitted from a D node to an R node.

FIG. 34 is a conceptual diagram illustrating exemplary embodiments of a signal transmitted from a D node to an R node.

FIG. 35 is a conceptual diagram illustrating exemplary embodiments of a signal transmitted from a D node to an R node.

FIG. 36 is a conceptual diagram illustrating exemplary embodiments of a method for delivering structure information of a signal transmitted from a D node to an R node.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

In the present disclosure, a phrase including “when ˜” may be expressed as a phrase including “based on ˜” or a phrase including “in response to ˜”. In other words, a phrase including “when ˜” may be interpreted as the same as or similar to a phrase including “based on ˜” or a phrase including “in response to ˜”.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

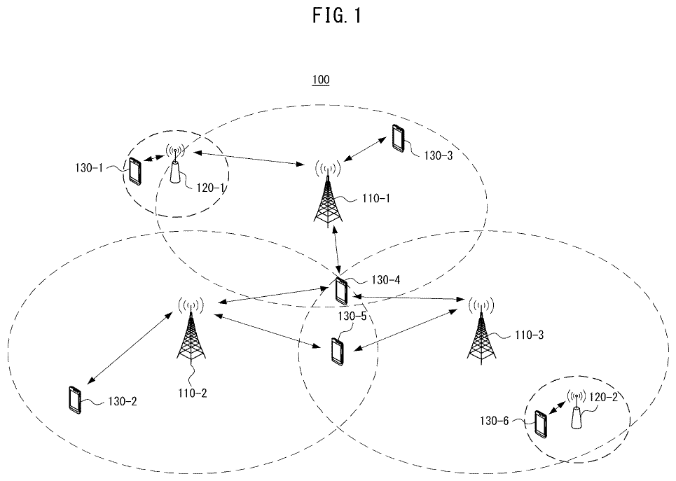

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

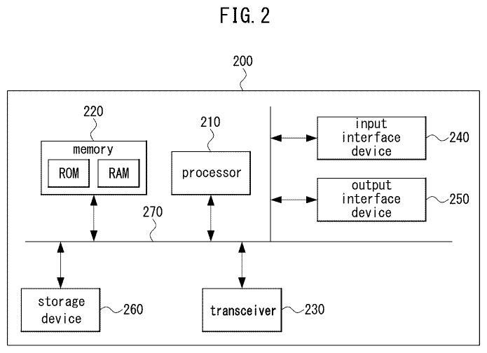

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of user equipments (UEs) 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third UE 130-3, and the fourth UE 130-4 may belong to the cell coverage of the first base station 110-1. Also, the second UE 130-2, the fourth UE 130-4, and the fifth UE 130-5 may belong to the cell coverage of the second base station 110-2. Also, the fifth base station 120-2, the fourth UE 130-4, the fifth UE 130-5, and the sixth UE 130-6 may belong to the cell coverage of the third base station 110-3. Also, the first UE 130-1 may belong to the cell coverage of the fourth base station 120-1, and the sixth UE 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of UE 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding UE 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), or the like. Here, each of the plurality of UEs 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, a 5G communication system may support a data delivery function according to service characteristics. The 5G communication system and data transmission technology may vary depending on service requirements in order to support the data delivery function according to service characteristics. The 5G communication system may apply technologies required by a considered service while maintaining basic operation procedures or signal structures as much as possible.

The services considered in the present disclosure may be Internet of things (IoT) services such as logistics tracking, process handling, industrial equipment operation monitoring, or equipment control in industries or factories. Additionally, the services considered in the present disclosure may be IoT services applicable across society, such as micro mobility or electric power metering.

IoT devices for such IoT services may be deployed in very large quantities of more than hundreds of billions, considering various applications while further reducing size, complexity, and power consumption. However, due to issues such as maintenance and management, it may be difficult to manually replace or recharge a battery of the IoT device. Therefore, IoT technology may require a new ambient IoT (AIoT) technology in order to support a device without energy storage capability, a device not equipped with a battery, a device that does not require manual battery replacement, or a device that does not require battery recharging.

In such an AIoT network, the IoT device may be a wireless device having lower complexity than a narrowband (NB)-IoT device or a long-term evolution machine type communication (LTE-MTC) device. In addition, the IoT device in the AIoT network may be a wireless device that does not have a battery. Alternatively, the IoT device in the AIoT network may be a wireless device that has a battery with limited capacity.

As described above, the wireless device considered in the present disclosure may operate without a battery. The wireless device considered in the present disclosure may operate in a state where the wireless device is not connected to an external power source. The wireless device considered in the present disclosure may acquire energy necessary for operations by harvesting, collecting, aggregating, or acquiring an energy source from the surrounding environment.

For example, the wireless device considered in the present disclosure may acquire energy necessary for operations from a wireless signal transmitted from a nearby wireless device. The wireless device considered in the present disclosure may backscatter a wireless signal received from another nearby wireless device and transmit the backscattered wireless signal. The wireless device considered in the present disclosure may be defined as an ambient IoT device or terminal that harvests energy from the surrounding environment. The ambient IoT terminal may, for convenience of description, be defined as an IoT device or terminal. The present disclosure is directed to providing a method and an apparatus for transmitting and receiving signals and control information in a communication system that enables IoT devices to operate with low power.

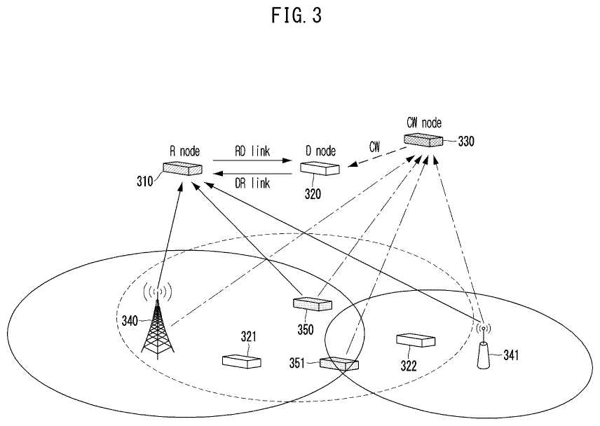

FIG. 3 is a conceptual diagram illustrating exemplary embodiments of a communication system including IoT devices.

Referring to FIG. 3, a communication node 310 may be a device that wirelessly transmits and receives data with an IoT device. The communication node 310 may be defined as a ‘reader’, ‘R node’, or ‘R-node’. A communication node 320 may be an AIoT device and may operate with low power. The communication node 320 may communicate with the reader. The communication node 320 may be defined as an ‘IoT device’, ‘IoT terminal’, ‘IoT node’, ‘I node’, or ‘I-node’. The communication node 320 may be defined as a ‘D node’ or ‘D-node’ as a device. A link from the communication node 310 to the communication node 320 may be referred to as an RI link or an RD link. Conversely, a link from the communication node 320 to the communication node 310 may be referred to as an IR link or a DR link.

A communication node 330 may emit or transmit a carrier wave (CW). The communication node 330 may be defined as a ‘CW-node’, ‘CW node’, ‘CW device’, or ‘CW terminal’. In addition, the communication node 330 may be defined as a carrier wave supplying terminal, a carrier wave terminal, or a carrier wave node. The communication node 330 may transmit the carrier wave to the IoT node. Then, the IoT node may collect, aggregate, or accumulate energy from the carrier wave. Furthermore, the IoT node may backscatter the carrier wave to transmit or provide a signal to the communication node 310. The communication node 310 may receive the signal transmitted through backscattering from the IoT node.

The reader, which is the communication node 310, may be a base station or terminal in the wireless communication network. The terminal may transmit and receive data as being connected with a base station and may refer to a user equipment (UE). The CW node, which is the communication node 330, may be a base station or terminal in the wireless communication network.

An I node 321 may be located at a distance capable of transmitting and receiving data with a base station 340. In such an operating environment, the base station 340 may operate as an R-node or CW-node with respect to the I-node 321. Alternatively, a terminal 350 may perform a role of an R-node or CW-node with respect to the I-node 321. Alternatively, an adjacent other base station may perform a function of an R-node or CW-node with respect to the I-node 321. The present disclosure defines a network environment of operating conditions of the above wireless devices as an ‘in-service condition’.

An I node 322 may be located at a distance not capable of at least transmitting or receiving with the base station 340. The I node 322 may operate with low power. In this case, the I node 322 may attempt to receive data from the base station 340. The I node 322 may transmit a signal having a signal strength equal to or smaller than a certain level. The base station 340 may have difficulty receiving data from the I node 322 without error.

The terminal 350 may perform a role of an R-node capable of transmitting and receiving data with the I node 322. The I node 322 may receive data from the base station 340. The I node 322 may transmit data to the terminal 350. The terminal 350 may receive data from the I node 322 and may deliver the data to the base station 340. Another terminal 351, other than the terminal 350 performing the role of the R-node, may perform a role of a CW-node. Alternatively, the base station 340 may perform a role of a CW-node. Alternatively, the base station 341 may perform a role of a CW-node.

Alternatively, the adjacent other base station 341 may perform a role of an R-node capable of transmitting and receiving data with the I node 322. In such a case, the I node 322 may receive data from the base station 340. Then, the I node 322 may transmit data to the adjacent other base station 341. The adjacent other base station 341 may receive data from the I node 322 and may deliver the received data to the base station 340. The base station 340 may receive the data from the adjacent other base station 341. The terminal 350 may perform a role of a CW-node. The present disclosure may define the above network environment as an ‘out-of-service condition’.

Methods for configuring transmission and reception channels, frequencies, or links of communication nodes in a wireless communication network are described. The wireless communication network may be composed of ‘R node’, ‘I node (or D node)’, and ‘CW node’. The ‘R node’ and ‘CW node’ may be implemented as at least physically the same communication node. The ‘R node’ or ‘CW node’ may be implemented as a base station or terminal. A signal link from the base station to the terminal may be referred to as a downlink, and a signal link from the terminal to the base station may be referred to as an uplink.

In the present disclosure, a link through which the R node transmits a signal to the D node may be defined as an RD link. A link through which the D node transmits a signal to the R node may be defined as a DR link. A link through which the CW-node transmits a signal to the D node may be defined as a CWD link.

In the present disclosure, the RD/DR/CWD link may be described as RD/DR/CWD link transmission or RD/DR/CWD transmission. However, as a detailed distinction, a link may refer to a connection between two nodes. The ‘transmission’ may refer to actual signal transmission performed while occupying wireless resources. For example, the ‘RD transmission’ may refer to a signal or a set of signals transmitted through the RD link during a certain time duration (e.g. a plurality of slots).

In addition, in the present disclosure, transmission resources of the RD/DR/CWD link may refer to a resource region in which transmission can be performed. The RD/DR/CWD transmission may refer to the transmission itself that is actually performed through the resource region. For convenience of description, the present disclosure may assume that RD/DR/CWD transmission is entirely performed over the RD/DR/CWD transmission resource region. In other words, the size or position of the resource region may be assumed to be the same as that of the actual transmission.

### [RD Transmission]

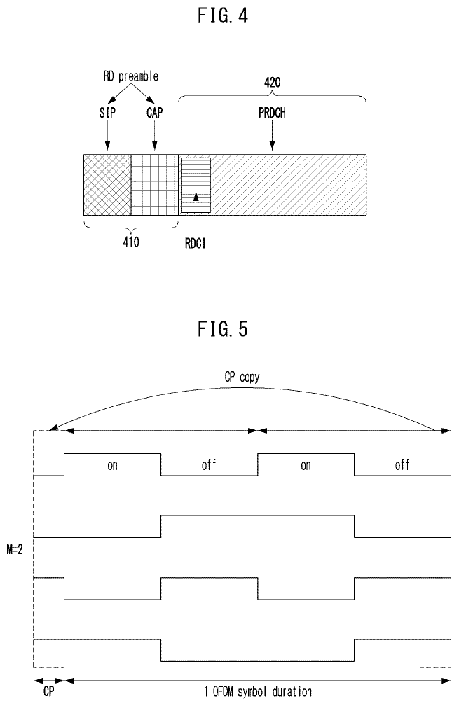

FIG. 4 is a conceptual diagram illustrating exemplary embodiments of a signal transmitted from an R node to a D node.

Referring to FIG. 4, a signal transmitted from an R node to a D node may include an RD preamble 410 for indicating a start of an RD transmission signal and a physical reader to device channel (PRDCH) 420. The RD preamble may precede the PRDCH. The PRDCH may follow the RD preamble. The RD preamble may be configured as a pattern or sequence. The RD preamble may include a start indicator part (SIP) for indicating the start of the RD transmission signal and a clock acquisition part (CAP) for enabling identification of information on a clock or chip.

The PRDCH may include at least one of higher-layer data, higher-layer information, or data to be delivered to the D node. The PRDCH may include RD control information (RDCI) as layer 1 (L1) control information. The RDCI may be configured to be separated so that the D node identifies the control information earlier than other data received together through the PRDCH. The separated configuration may mean that the R node independently processes the control information (e.g. a bit information sequence) with at least one of an error correction channel coding or a cyclic redundancy check (CRC).

The R node may modulate data or bits by using an on-off keying (OOK) scheme in consideration of the D node operating with low power. The R node may transmit the data or bits modulated by using the on-off keying scheme to the D node through the PRDCH. The D node may receive the data or bits modulated by using the on-off keying scheme from the R node through the PRDCH.

In the present disclosure, the R node may encode a final bit sequence to be delivered to the D node using a line code. The present disclosure may define the process of encoding using a line code as line encoding. The R node may modulate the bit sequence encoded using a line code into OOK symbols by using the on-off keying scheme. The R node may transmit the OOK symbols to the D node through the PRDCH. The D node may receive the OOK symbols from the R node through the PRDCH. The line encoding may be Manchester encoding (ME) or pulse interval encoding (PIE). The OOK symbol encoded using the line code may be an OOK on symbol or OOK off symbol.

The OOK on symbol or OOK off symbol encoded using a line code may correspond to a single chip. A chip may be defined as an on chip or an off chip. An on chip may have a high voltage. An off chip may have a low voltage. For example, in ME, a bit 0 may be defined as chips [1, 0]. The chips [1, 0] may include an OOK on symbol and an OOK off symbol. The OOK on symbol may have a high voltage. The OOK off chip may have a low voltage.

A set of one on chip and one off chip may be defined as a single bit-chip. In other words, information bits may be encoded based on ME. Each of the information bits may be defined as chips. For example, a bit 1 may be encoded as chips [1, 0] based on ME. A bit 0 may be encoded as chips [0, 1] based on ME. A chip 1 may be an OOK on symbol. A chip 0 may be an OOK off symbol.

FIG. 5 is a conceptual diagram illustrating exemplary embodiments of a method for configuring OOK symbols in an orthogonal frequency division multiplexing (OFDM) symbol duration.

Referring to FIG. 5, an R node may configure OOK symbol(s) of an RD transmission signal in an OFDM symbol duration including cyclic prefix (CP). Here, a duration may mean a time duration, and a duration and a time duration may be used interchangeably with the same meaning. The R node may configure OOK symbol(s) of the RD transmission signal as an OFDM symbol including CP. The R node may transmit the OFDM symbol including CP to the D node. The D node may receive the OFDM symbol including CP from the R node. The D node may acquire the OOK symbol(s) from the received OFDM symbol. Alternatively, the R node may configure OOK symbol(s) of an RD transmission signal in a discrete Fourier transform spread orthogonal frequency division multiplexing (DFT-s-OFDM) symbol duration including CP. The R node may configure OOK symbol(s) of the RD transmission signal as a DFT-s-OFDM symbol including CP. The R node may transmit the DFT-s-OFDM symbol to the D node. The D node may receive the DFT-s-OFDM symbol including CP from the R node. The D node may acquire the OOK symbol(s) from the DFT-s-OFDM symbol.

For example, an OOK-1 transmission configuration may mean a configuration for transmitting a single bit-chip by configuring the single bit-chip in one OFDM symbol or DFT-s-OFDM symbol duration. An OOK-M transmission configuration may mean a configuration for transmitting M single bit-chips by configuring the M single bit-chips in one OFDM symbol or DFT-s-OFDM symbol duration. M may be a positive integer and may be a number of the single bit-chips. The R node may configure a PRDCH based on the OOK-M transmission configuration.

The R node may configure M single bit-chips in an OFDM symbol duration or DFT-s-OFDM symbol duration of the PRDCH. As M increases, a time duration length of one chip may decrease. Alternatively, each of one OOK on symbol or one OOK off symbol may be defined as one chip. In such a case, as M increases, a time duration length of a chip may decrease. For example, in FIG. 5, M may be 2, and the R node may configure 2 single bit-chips in one OFDM symbol. In other words, the R node may configure 2 information bits in one OFDM symbol.

Referring again to FIG. 4, the SIP may be configured with one or more OOK on symbols and one or more OOK off symbols. A unit time duration of each of the OOK on symbols and the OOK off symbols may be the same as at least one of a time duration of an on/off transition or off/on transition of the line code of the PRDCH, a chip time duration, or a unit time duration, unless otherwise specifically mentioned. A total time duration of the SIP may be one of multiples of an OFDM symbol duration including CP, unless otherwise specifically mentioned.

In a first exemplary embodiment, the SIP may be configured with one OOK on symbol and one OOK off symbol. A time duration length of the OOK on symbol and a time duration length of the OOK off symbol may be equal to each other. For example, the time duration length of the OOK on symbol may be equal to a time duration length of one OFDM symbol in the PRDCH. Alternatively, the time duration length of the OOK on symbol may be equal to a time duration length of two OFDM symbols. The time duration length of the OFDM symbol may be equal to a time duration length of an OFDM symbol including CP.

In a second exemplary embodiment, the SIP may be configured with one OOK on symbol and one OOK off symbol. A time duration length of the OOK on symbol and a time duration length of the OOK off symbol may be different from each other. For example, the time duration length of the OOK on symbol may be equal to a time duration length of one OFDM symbol in the PRDCH. Alternatively, the time duration length of the OOK on symbol may be equal to a time duration length of two OFDM symbols. The time duration length of the OFDM symbol may be equal to a time duration length of an OFDM symbol including CP. The time duration length of the OOK off symbol may be equal to a time duration length of CP. The OOK off symbol may be after the OOK on symbol. For example, a CP duration of the CAP transmitted after the SIP may be configured as the OOK off symbol.

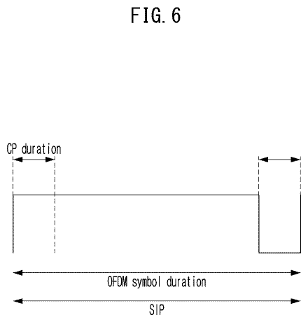

FIG. 6 is a conceptual diagram illustrating exemplary embodiments of a method for configuring a start indicator part.

Referring to FIG. 6, an R node may configure an OOK on symbol in a partial duration excluding a CP duration in an OFDM symbol duration, and may configure an OOK off symbol having a time duration equal to the CP duration in the remaining duration. The total time duration of the SIP may be equal to the time duration length of the OFDM symbol including CP.

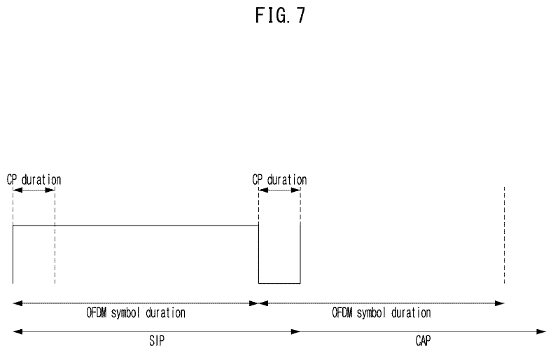

FIG. 7 is a conceptual diagram illustrating exemplary embodiments of a method for configuring a start indicator part.

Referring to FIG. 7, for an SIP, an R node may configure an OOK on symbol in a duration excluding a CP duration in a first OFDM symbol duration, and may configure an OOK off symbol during a CP duration in a second OFDM symbol duration. A time duration length for the entire SIP may be a length obtained by summing the first OFDM symbol duration including a CP duration and another CP duration. The R node may configure a CAP in the second OFDM symbol.

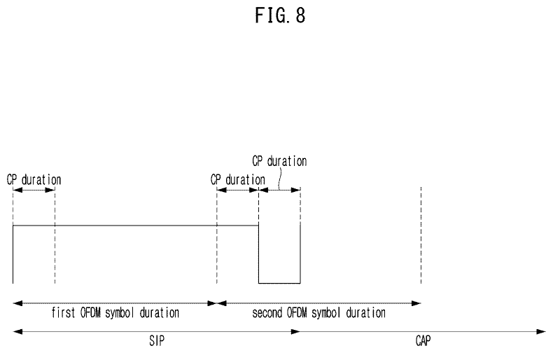

FIG. 8 is a conceptual diagram illustrating exemplary embodiments of a method for configuring a start indicator part.

Referring to FIG. 8, for an SIP, an R node may configure an OOK on symbol in a duration excluding a CP duration in a first OFDM symbol duration, and may configure an OOK on symbol in a time duration for one CP in a second OFDM symbol duration, and continuously may configure an OOK off symbol in a time duration for another one CP in the second OFDM symbol duration. The R node may configure a CAP in the second OFDM symbol duration.

A time duration length for the entire SIP may be a length obtained by summing a length of the OFDM symbol duration including CP and lengths of two CP durations. The CAP may be configured in a duration excluding durations for the two CPs in the second OFDM symbol duration. The time duration length for the entire SIP and the time duration length for the CAP may be a multiple of an OFDM symbol duration.

Regarding an SIP structure, a D node may receive an RD transmission signal from the R node. The D node may acquire a time duration of an OOK on symbol from the received RD transmission signal, and when the duration of the acquired OOK on symbol is equal to or longer than a predetermined time, the D node may assume the duration of the OOK on symbol as the duration of the SIP In such a case, the D node may determine a start portion of the OOK on symbol as a start portion of the RD transmission signal. The D node may assume that the time duration for the SIP is ended when a time duration for an OOK off symbol appears after the time duration of the OOK on symbol continues for the predetermined time. The D node may determine that a time duration for transmission of the CAP is started after the time duration for the SIP is ended in the RD transmission signal.

The duration of the OOK on symbol may not last for a time equal to or longer than the predetermined time. In such a case, the D node may assume that the time duration of the OOK on symbol is not a time duration for transmission of the SIP, and may determine that the SIP cannot be detected. When the D node determines that the SIP cannot be detected in the RD transmission signal, the D node may transition to a state for minimizing energy consumption. The D node may perform only operations necessary for SIP detection in the state for minimizing energy consumption. For example, the D node may perform only an SIP monitoring operation to minimize energy consumption. A time duration length of the OOK on symbol equal to or longer than the predetermined time may be a half of a time duration length for an OFDM symbol excluding CP. The time duration length of the OOK on symbol equal to or longer than the predetermined time may be equal to a time duration length for an OFDM symbol excluding CP.

Meanwhile, a number M of single bit-chips may be 2. In such a case, a configuration of an OFDM symbol transmittable in the PRDCH may be as shown in FIG. 5. The R node may configure an OOK on symbol or an OOK off symbol by using three consecutive chips during one OFDM symbol duration, in order to allow the D node to distinguish it from PRDCH symbols for all possible values of M in the PRDCH.

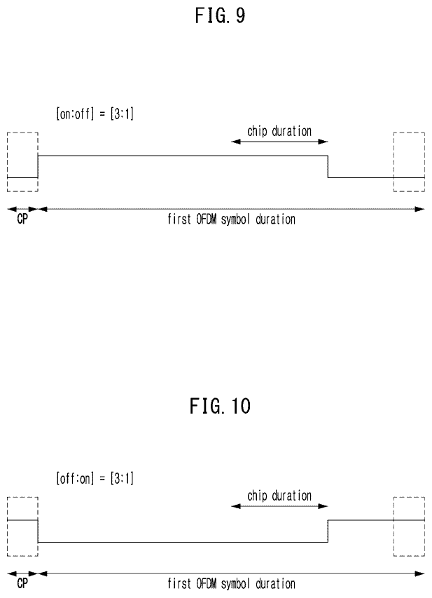

FIG. 9 is a conceptual diagram illustrating exemplary embodiments of a method for configuring a start indicator part.

Referring to FIG. 9, an R node may configure 3 on chips consecutively in one OFDM symbol duration and may configure 1 off chip subsequently. The R node may transmit an RD transmission signal configured as described above to the D node. The D node may receive the RD transmission signal from the R node. The D node may acquire a time duration of an OOK on symbol in the received RD transmission signal, and when the acquired time duration of the OOK on symbol lasts for a time equal to or longer than a predetermined time, the D node may assume the time duration for the OOK on symbol as a time duration for an SIP. In such a case, the D node may determine a start portion of the OOK on symbol as a start portion of the RD transmission signal. The D node may assume that the time duration for the SIP is ended when a time duration for an OOK off symbol appears after the time duration of the OOK on symbol lasts for the predetermined time. The D node may determine that a time duration for transmission of a CAP is started after the time duration for the SIP is ended in the RD transmission signal.

The time duration of the OOK on symbol may not last for a time equal to or longer than the predetermined time. In such a case, the D node may assume that the time duration of the OOK on symbol is not a time duration for transmission of the SIP, and may determine that the SIP cannot be detected. When the D node determines that the SIP cannot be detected in the RD transmission signal, the D node may transition to a state for minimizing energy consumption. The D node may perform only operations necessary for SIP detection in the state for minimizing energy consumption. For example, the D node may perform only an SIP monitoring operation to minimize energy consumption. A time duration length of the OOK on symbol equal to or longer than the predetermined time may be a half of a time duration length for an OFDM symbol excluding CP. The time duration length of the OOK on symbol equal to or longer than the predetermined time may be equal to a time duration length for an OFDM symbol excluding CP.

FIG. 10 is a conceptual diagram illustrating exemplary embodiments of a method for configuring a start indicator part.

Referring to FIG. 10, an R node may configure 3 off chips consecutively in one OFDM symbol duration and may configure 1 on chip subsequently. The R node may transmit an RD transmission signal configured as described above to the D node. The D node may receive the RD transmission signal from the R node. The D node may acquire a time duration of an OOK off symbol in the received RD transmission signal, and when the acquired time duration of the OOK off symbol lasts for a time equal to or longer than a predetermined time, the D node may assume the time duration for the OOK off symbol as a time duration for an SIP.

In such a case, the D node may determine a start portion of the OOK off symbols as a start portion of the RD transmission signal. The D node may assume that the time duration for the SIP is ended when a time duration for an OOK on symbol appears after the time duration of the OOK off symbol lasts for the predetermined time. The D node may determine that a time duration for transmission of a CAP is started after the time duration for the SIP is ended in the RD transmission signal.

The time duration of the OOK off symbol may not last for a time equal to or longer than the predetermined time. In such a case, the D node may assume that the time duration of the OOK off symbol is not a time duration for transmission of the SIP, and may determine that the SIP cannot be detected. When the D node determines that the SIP cannot be detected in the RD transmission signal, the D node may transition to a state for minimizing energy consumption. The D node may perform only operations necessary for SIP detection in the state for minimizing energy consumption.

For example, the D node may perform only an SIP monitoring operation to minimize energy consumption. A time duration length of the OOK off symbol equal to or longer than the predetermined time may be a half of a time duration length for an OFDM symbol excluding CP. The time duration length of the OOK off symbol equal to or longer than the predetermined time may be equal to a time duration length for an OFDM symbol excluding CP.

As illustrated in FIG. 9 or FIG. 10, the RD transmission signal may include the SIP. In a time duration for one OFDM symbol in the RD transmission signal, the OOK on symbol or OOK off symbol may have a length of two or more chip durations and may include up to three consecutive chip durations. In such a case, the D node may assume the time duration for the OOK on symbol or the OOK off symbol as the time duration for the SIP.

The D node may determine a start portion of the OOK on symbol or a start portion of the OOK off symbol as a start portion of the RD transmission signal. The D node may assume that the time duration for the SIP is ended when a time duration for an OOK off symbol appears after the time duration of the OOK on symbol lasts for the predetermined time. Alternatively, the D node may assume that the time duration for the SIP is ended when a time duration for an OOK on symbol appears after the time duration of the OOK off symbol lasts for the predetermined time.

In other words, when the D node performs energy detection and detects the OOK on symbol (refer to FIG. 9) or OOK off symbol (refer to FIG. 10) continuously for a duration exceeding two and less than four chip durations, the D node may determine the corresponding duration as a start duration of the RD transmission. In addition, the D node may determine a transition time as a start time of the CAP when a state of the opposite polarity (the OOK off symbol or the OOK on symbol) continues for a chip duration after the OOK on symbols or the OOK off symbols and when a transition of energy or voltage is sensed after a duration for the CP.

In a third exemplary embodiment, an SIP may be configured with one or more OOK on symbols and one or more OOK off symbols. Time duration lengths of the OOK on symbol(s) and the OOK off symbol(s) may be equal to each other.

In a fourth exemplary embodiment, an SIP may be configured with one or more OOK on symbols and one or more OOK off symbols. Lengths of the OOK on symbol(s) and the OOK off symbol(s) may be different from each other. For example, a time duration length of one OOK on symbol may be equal to a time duration length of one OFDM symbol in a PRDCH. A time duration length of one OOK off symbol may be equal to a CP length. A time duration length of an OOK on symbol may be equal to a time duration length of an OFDM symbol excluding CP. A time duration length of an OOK on symbol may be equal to a length of a time duration for an OFDM symbol including CP.

In another example, an R node may configure an OOK on symbol and an OOK off symbol alternately twice in a time duration for one OFDM symbol. For example, the R node may configure OOK symbols in an order of an OOK on symbol, an OOK off symbol, an OOK on symbol, and an OOK off symbol in the time duration for one OFDM symbol. A time duration length of the OOK off symbol may be equal to a length of a time duration for an OFDM symbol excluding CP. Alternatively, the time duration length of the OOK off symbol may be equal to a length of a time duration for an OFDM symbol including CP.

In another example, an R node may configure a plurality of OOK on symbols and/or OOK off symbols in a time duration for an OFDM symbol. A configuration of an OFDM symbol transmittable in the PRDCH when M=2 may be as shown in FIG. 5. The R node may configure an OOK on symbol or an OOK off symbol by using three consecutive chips during one OFDM symbol duration, in order to allow the D node to distinguish it from PRDCH symbols for all possible values of M in the PRDCH.

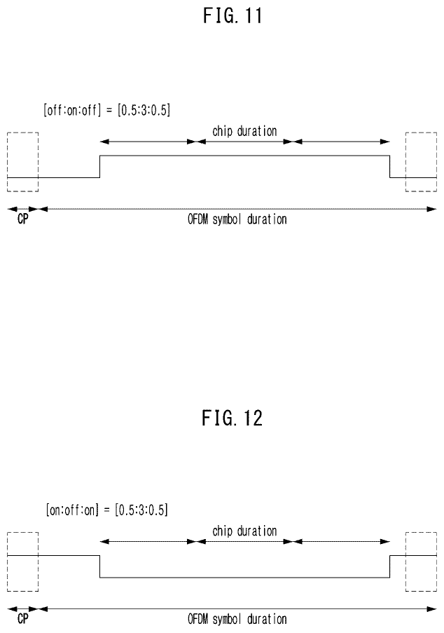

FIG. 11 is a conceptual diagram illustrating exemplary embodiments of a method for configuring a start indicator part.

Referring to FIG. 11, an R node may consecutively configure three on chips in one OFDM symbol duration. The R node may configure one off chip before the three on chips in one OFDM symbol duration. In addition, the R node may configure one off chip consecutively after the three on chips in one OFDM symbol duration. A chip duration (e.g. referred to as a first chip duration) for each of the three on chips may be a chip duration for a case where M is 2. A chip duration (e.g. referred to as a second chip duration) for each of the two off chips may be a chip duration for a case where M is 4. A length of the first chip duration may be twice a length of the second chip duration.

The R node may transmit an RD transmission signal configured as described above to the D node. The D node may receive the RD transmission signal from the R node. The D node may acquire a time duration of an OOK on symbol in the received RD transmission signal, and when the acquired time duration of the OOK on symbol lasts for a time equal to or longer than a predetermined time, the D node may assume the time duration for the OOK on symbol as a time duration for an SIP. In such a case, the D node may determine a start portion of an OOK off symbol preceding the OOK on symbol as a start portion of the RD transmission signal. The D node may assume that the time duration for the SIP is ended when the time duration for the OOK off symbol appears after the time duration of the OOK on symbol lasts for the predetermined time. The D node may determine that a time duration for transmission of a CAP is started after the time duration for the SIP is ended in the RD transmission signal.

The time duration of the OOK on symbol may not last for a time equal to or longer than the predetermined time. In such a case, the D node may assume that the time duration of the OOK on symbol is not a time duration for transmission of the SIP, and may determine that the SIP cannot be detected. When the D node determines that the SIP cannot be detected in the RD transmission signal, the D node may transition to a state for minimizing energy consumption.

The D node may perform only operations necessary for SIP detection in the state for minimizing energy consumption. For example, the D node may perform only an SIP monitoring operation to minimize energy consumption. A time duration length of the OOK on symbol equal to or longer than the predetermined time may be a half of a time duration length for an OFDM symbol excluding CP. The time duration length of the OOK on symbol equal to or longer than the predetermined time may be equal to a time duration length for an OFDM symbol excluding CP.

FIG. 12 is a conceptual diagram illustrating exemplary embodiments of a method for configuring a start indicator part.

Referring to FIG. 12, an R node may consecutively configure three off chips in one OFDM symbol duration. The R node may configure one on chip before the three off chips in one OFDM symbol duration. In addition, the R node may configure one on chip consecutively after the three off chips in one OFDM symbol duration. A chip duration (e.g. referred to as a first chip duration) for each of the three off chips may be a chip duration for a case where M is 2. A chip duration (e.g. referred to as a second chip duration) for each of the two on chips may be a chip duration for a case where M is 4. A length of the first chip duration may be twice a length of the second chip duration.

The R node may transmit an RD transmission signal configured as described above to the D node. The D node may receive the RD transmission signal from the R node. The D node may acquire a time duration of an OOK off symbol in the received RD transmission signal, and when the acquired time duration of the OOK off symbol lasts for a time equal to or longer than a predetermined time, the D node may assume the time duration for the OOK off symbol as a time duration for an SIP. In such a case, the D node may determine a start portion of an OOK on symbol preceding the OOK off symbol as a start portion of the RD transmission signal. The D node may assume that the time duration for the SIP is ended when the time duration for the OOK on symbol appears after the time duration of the OOK off symbol lasts for the predetermined time. The D node may determine that a time duration for transmission of a CAP is started after the time duration for the SIP is ended in the RD transmission signal.

The time duration of the OOK off symbol may not last for a time equal to or longer than the predetermined time. In such a case, the D node may assume that the time duration of the OOK off symbol is not a time duration for transmission of the SIP, and may determine that the SIP cannot be detected. When the D node determines that the SIP cannot be detected in the RD transmission signal, the D node may transition to a state for minimizing energy consumption. The D node may perform only operations necessary for SIP detection in the state for minimizing energy consumption.

For example, the D node may perform only an SIP monitoring operation to minimize energy consumption. A time duration length of the OOK off symbol equal to or longer than the predetermined time may be a half of a time duration length for an OFDM symbol excluding CP. The time duration length of the OOK off symbol equal to or longer than the predetermined time may be equal to a time duration length for an OFDM symbol excluding CP.

In other words, when the D node performs energy detection and detects the OOK on symbol (refer to FIG. 11) or OOK off symbol (refer to FIG. 12) continuously for a duration exceeding two and less than four chip durations, the D node may determine the corresponding duration as a start duration of the RD transmission. In addition, when, after such OOK on symbol or OOK off symbol, a state of an opposite polarity (an OOK off symbol or an OOK on symbol) lasts for a chip duration for a case where M is 4, and a transition of energy or voltage is sensed after a time duration for the CP, the D node may determine the transition time as a start time of the CAP. In another example, the R node may configure a plurality of OOK on symbols and/or OOK off symbols during the time duration for the OFDM symbol.

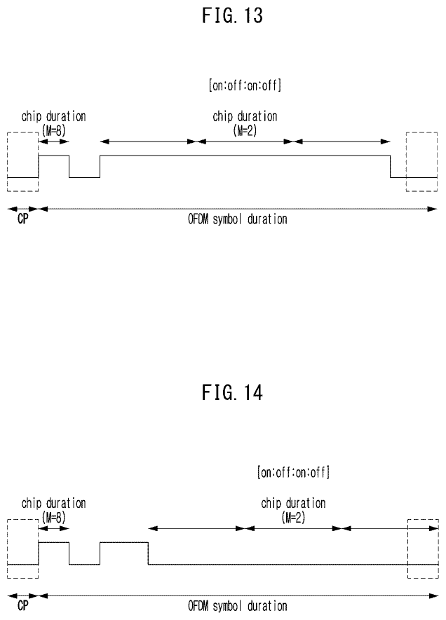

FIG. 13 is a conceptual diagram illustrating exemplary embodiments of a method for configuring a start indicator part.

Referring to FIG. 13, an R node may consecutively configure three on chips in one OFDM symbol duration. The R node may configure one on chip and one off chip before the three on chips in one OFDM symbol duration. In other words, the R node may configure one on chip in a chip duration for a case where M is 8 before the three on chips, and may consecutively configure one off chip in a chip duration for a case where M is 8. In addition, the R node may configure one off chip consecutively after the three on chips in one OFDM symbol duration. A chip duration (e.g. referred to as a first chip duration) for each of the three on chips may be a chip duration for a case where M is 2. A chip duration (e.g. referred to as a second chip duration) for one off chip consecutive to the three on chips may be a chip duration for a case where M is 4. A chip duration (e.g. referred to as a third chip duration) for each of one on chip and one off chip preceding the three on chips may be a chip duration for a case where M is 8. A length of the first chip duration may be twice a length of the second chip duration. A length of the second chip duration may be twice a length of the third chip duration.

The R node may transmit an RD transmission signal configured as described above to the D node. The D node may receive the RD transmission signal from the R node. The D node may acquire a time duration of the OOK on symbol in the received RD transmission signal, and when the acquired time duration of the OOK on symbol lasts for a time equal to or longer than a predetermined time, the D node may assume the time duration for the OOK on symbol as a time duration for an SIP.

In such a case, the D node may determine a start portion of the OOK on symbol preceding the OOK on symbol as a start portion of the RD transmission signal. The D node may assume that the time duration for the SIP is ended when a time duration for an OOK off symbol appears after the time duration of the OOK on symbol lasts for the predetermined time. The D node may determine that a time duration for transmission of a CAP is started after the time duration for the SIP is ended in the RD transmission signal.

The time duration of the OOK on symbol may not last for a time equal to or longer than the predetermined time. In such a case, the D node may assume that the time duration of the OOK on symbol is not a time duration for transmission of the SIP, and may determine that the SIP cannot be detected. When the D node determines that the SIP cannot be detected in the RD transmission signal, the D node may transition to a state for minimizing energy consumption.

The D node may perform only operations necessary for SIP detection in the state for minimizing energy consumption. For example, the D node may perform only an SIP monitoring operation to minimize energy consumption. A time duration length of the OOK on symbol equal to or longer than the predetermined time may be a half of a time duration length for an OFDM symbol excluding CP. The time duration length of the OOK on symbol equal to or longer than the predetermined time may be equal to a time duration length for an OFDM symbol excluding CP.

FIG. 14 is a conceptual diagram illustrating exemplary embodiments of a method for configuring a start indicator part.

Referring to FIG. 14, an R node may consecutively configure three off chips in one OFDM symbol duration. The R node may configure one on chip, one off chip, and one on chip before the three off chips in one OFDM symbol duration. In other words, the R node may configure one on chip in a chip duration for a case where M is 8 before the three on chips, and may consecutively configure one off chip in a chip duration for a case where M is 8. The R node may configure one on chip in a chip duration for a case where M is 4 consecutive to the one off chip.

A chip duration (e.g. referred to as a first chip duration) for each of the three on chips may be a chip duration for a case where M is 2. A chip duration (e.g. referred to as a second chip duration) for each of one on chip and one off chip preceding the three on chips may be a chip duration for a case where M is 8. A chip duration (e.g. referred to as a third chip duration) for one on chip that may precede the three on chips and that is consecutive to the one off chip may be a chip duration for a case where M is 4. A length of the first chip duration may be twice a length of the third chip duration. A length of the second chip duration may be twice a length of the third chip duration.

The R node may transmit an RD transmission signal configured as described above to the D node. The D node may receive the RD transmission signal from the R node. The D node may acquire a time duration of the OOK off symbol in the received RD transmission signal, and when the acquired time duration of the OOK off symbol lasts for a time equal to or longer than a predetermined time, the D node may assume the time duration for the OOK off symbol as a time duration for an SIP.

In such a case, the D node may determine a start portion of an OOK on symbol earliest preceding the OOK off symbol as a start portion of the RD transmission signal. The D node may assume that the time duration for the SIP is ended when a time duration for an OOK on symbol appears after the time duration of the OOK off symbol lasts for the predetermined time. The D node may determine that a time duration for transmission of a CAP is started after the time duration for the SIP is ended in the RD transmission signal.

The time duration of the OOK off symbol may not last for a time equal to or longer than the predetermined time. In such a case, the D node may assume that the time duration of the OOK off symbol is not a time duration for transmission of the SIP, and may determine that the SIP cannot be detected. When the D node determines that the SIP cannot be detected in the RD transmission signal, the D node may transition to a state for minimizing energy consumption. The D node may perform only operations necessary for SIP detection in the state for minimizing energy consumption.

For example, the D node may perform only an SIP monitoring operation to minimize energy consumption. A time duration length of the OOK off symbol equal to or longer than the predetermined time may be a half of a time duration length for an OFDM symbol excluding CP. The time duration length of the OOK off symbol equal to or longer than the predetermined time may be equal to a time duration length for an OFDM symbol excluding CP.

In other words, when the D node performs energy detection and detects the OOK on symbol (refer to FIG. 13) or OOK off symbol (refer to FIG. 14) continuously for a duration exceeding two and less than four chip durations, the D node may determine the corresponding duration as a start duration of the RD transmission. In addition, when, after such OOK on symbol or OOK off symbol, a state of an opposite polarity (an OOK off symbol or an OOK on symbol) lasts for a chip duration for a case where M is 4, and a transition of energy or voltage is sensed after a time duration for the CP, the D node may determine the transition time as a start time of the CAP.

In a fifth exemplary embodiment, an SIP may be configured with a predetermined sequence. A sequence may mean a sequence composed of 0 and 1, and 0 and 1 may be configured as one of an OOK on symbol and an OOK off symbol. The sequence may be one predefined sequence. Alternatively, one or more sequences suitable for multiple purposes may be configured. For example, the R node and the D node may apply different sequences to distinguish between RD transmission and DR transmission. Alternatively, the R node may transmit a different sequence according to a PRDCH structure of the RD transmission. Alternatively, the R node may transmit a different sequence according to a structure of the DR transmission.

Meanwhile, the CAP may include information on a length of a time duration of a chip constituting single bit-chips of the PRDCH or information on a chip duration of an OOK on symbol or an OOK off symbol at a minimum. The R node may transmit the CAP to the D node by using a pattern or a sequence predetermined with the D node so that the D node is able to know information on the time duration length of the chip constituting the single bit-chips of the PRDCH or information on the chip duration of the OOK on symbol or the OOK off symbol. The D node may receive the CAP including the information on the time duration length of the chip or the information on the chip duration of the OOK on symbol or the OOK off symbol from the R node. The D node may acquire the information on the time duration length of the chip or the information on the chip duration of the OOK on symbol or the OOK off symbol from the received CAP.

The CAP may be configured with at least two rising edges and at least two falling edges. The D node may acquire information on the time duration length of a unit chip of the single bit-chips of the PRDCH or of the OOK on symbol or the OOK off symbol, or chip duration information, from a time interval between at least two rising edges and at least two falling edges.

The durations of the OOK on symbol and the OOK off symbol of the CAP may vary depending on M of the PRDCH. The R node may configure the OOK on symbol and the OOK off symbol of the CAP to correspond to a chip duration or M of the PRDCH and may transmit the CAP to the D node. The D node may receive the CAP including the OOK on symbol and the OOK off symbol configured to correspond to the chip duration or M of the PRDCH. The D node may estimate M from the durations of the OOK on symbol and the OOK off symbol of the received CAP. The D node may estimate the chip duration of the PRDCH from the durations of the OOK on symbol and the OOK off symbol of the received CAP. The D node may estimate the chip duration by measuring the time duration length of the OOK on symbol or the OOK off symbol. The D node may detect a rising edge and/or a falling edge of the OOK on symbol and the OOK off symbol and may determine an interval between the edges to estimate the chip duration.

The CAP may be configured in consideration of a CP or a CP length of an OFDM symbol of the PRDCH. The R node may configure the CAP in consideration of the CP or CP length of the OFDM symbol of the PRDCH. For example, a CP duration in the CAP may be configured as a pattern. The D node may determine the pattern as the CP. The D node may estimate the chip duration of the OOK on symbol and the OOK off symbol from a duration excluding the CP duration. The D node may estimate M from the duration excluding the CP duration.

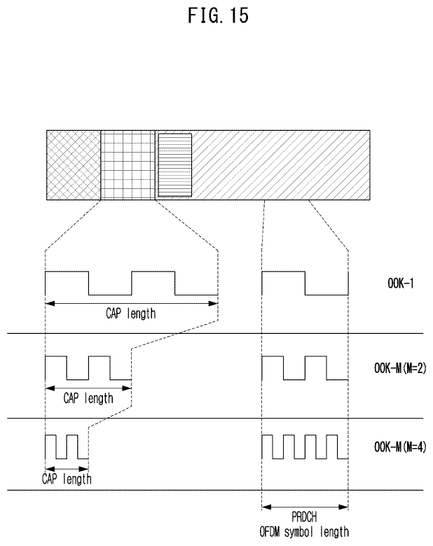

As another configuration method of the CAP, the R node may configure the CAP without considering the CP or CP length of the OFDM symbol of the PRDCH. For example, the CP duration in the CAP may be configured as a pattern. The D node may determine the pattern as the CP. The D node may estimate the chip duration of the OOK on symbol and the OOK off symbol from a duration excluding the CP duration. The D node may estimate M from the duration excluding the CP duration. As another example, the CAP may not consider the CP duration and may be configured with the on and off symbols or a pattern. The D node may estimate the chip duration of the on and/or off symbols. The D node may estimate M. FIGS. 15 to 25 may not represent the CP configuration for convenience regarding the time duration of the OFDM symbol of the PRDCH and may represent the OOK on symbol and the OOK off symbol according to OOK-M including M=1.

In a first exemplary embodiment, as M increases, the length of the chip duration may decrease. Accordingly, the durations of the on and off symbols in the CAP or the chip duration may similarly decrease.

FIG. 15 is a conceptual diagram illustrating exemplary embodiments of a method for configuring a clock acquisition part.

Referring to FIG. 15, an R node may configure a CAP of an RD preamble with two single-bit chips. The CAP may have two rising edges and two falling edges. A chip duration of the two single-bit chips for a case where M=1 may be referred to as a first chip duration. A chip duration of the two single-bit chips for a case where M=2 may be referred to as a second chip duration. A chip duration of the two single-bit chips for a case where M=4 may be referred to as a third chip duration. As M increases, the length of the chip duration may decrease. Accordingly, the durations of on and off symbols or the chip duration in the CAP may similarly decrease. The D node may receive the RD preamble including the CAP from the R node.

A time duration length of the CAP configured with two single-bit chips for a case where M=1 may be referred to as a first time duration. A time duration length of the CAP configured with two single-bit chips for a case where M=2 may be referred to as a second time duration. A time duration length of the CAP configured with two single-bit chips for a case where M=4 may be referred to as a third time duration.

The D node may identify the chip duration of the PRDCH or the M value of OOK-M based on a transition interval of an OOK on symbol and an OOK off symbol of the CAP. Alternatively, the D node may estimate the chip duration of the PRDCH from durations of the time duration of the OOK on symbol and/or the OOK off symbol of the CAP. The time duration length of the OOK on symbol and the time duration length of the OOK off symbol may be identical. When the R node makes the time duration length of the OOK off symbol and the time duration length of the OOK on symbol different for a purpose such as CP duration processing, the D node may estimate the chip duration or the M value from information regarding one of the time duration of one of the OOK on symbol or the OOK off symbol.

The time duration length of the CAP may be independent of a time duration length of an OFDM symbol. Therefore, the CAP may not include CP. The D node may not consider CP and may estimate the chip duration of the OOK symbol of the PRDCH by measuring the duration of the OOK on symbol and/or the OOK off symbol. However, a total length of a time duration of the SIP and the CAP may be a multiple of a time duration length of an OFDM symbol. In such a case, the D node may assume that the OFDM symbol of the PRDCH starts after the time duration of the last OOK off symbol of the CAP.

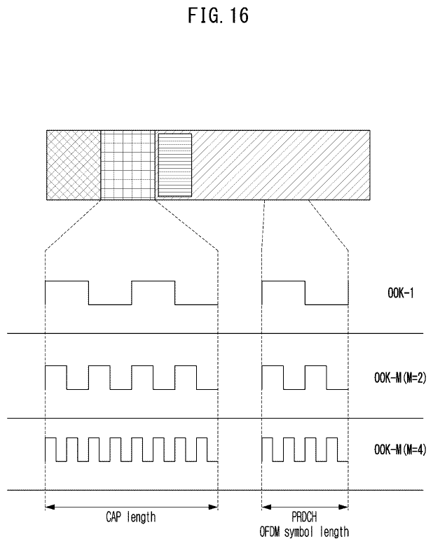

FIG. 16 is a conceptual diagram illustrating exemplary embodiments of a method for configuring a clock acquisition part.

Referring to FIG. 16, an R node may configure a CAP of an RD preamble with two single-bit chips for a case where M=1. The CAP may have two rising edges and two falling edges. The R node may configure a CAP of an RD preamble with four single-bit chips for a case where M=2. The CAP may have four rising edges and four falling edges. The R node may configure a CAP of an RD preamble with eight single-bit chips for a case where M=4. The CAP may have eight rising edges and eight falling edges.

A chip duration of the two single-bit chips for a case where M=1 may be referred to as a first chip duration. A chip duration of the four single-bit chips for a case where M=2 may be referred to as a second chip duration. A chip duration of the eight single-bit chips for a case where M=4 may be referred to as a third chip duration. As M increases, the length of the chip duration may decrease. However, a length of the CAP may be configured to be identical regardless of M. The D node may receive the RD preamble including the CAP from the R node.

A time duration length of the CAP configured with two single-bit chips for a case where M=1 may be referred to as a first time duration. A time duration length of the CAP configured with four single-bit chips for a case where M=2 may be referred to as a second time duration. A time duration length of the CAP configured with eight single-bit chips for a case where M=4 may be referred to as a third time duration. The lengths of the first time duration, the second time duration, and the third time duration may be identical. In other words, the lengths of the CAP in various M values may be identical. When M increases, lengths of patterns of two OOK on symbols and/or OOK off symbols may decrease, and the patterns may be configured with a structure repeated M times.

The D node may identify the chip duration of the PRDCH or the M value of OOK-M based on a transition interval of an OOK on symbol and an OOK off symbol of the CAP. Alternatively, the D node may estimate the chip duration of the PRDCH or M value of OOK-M from the number of repetitions of the OOK on symbol or the OOK off symbol of the CAP or from the pattern. Alternatively, the D node may estimate the chip duration of the PRDCH from durations of the time duration of the OOK on symbol and/or the OOK off symbol of the CAP. The time duration length of the OOK on symbol and the time duration length of the OOK off symbol may be identical. When the R node makes the time duration length of the OOK off symbol and the time duration length of the OOK on symbol different for a purpose such as CP duration processing, the D node may estimate the chip duration or the M value by using one of the time duration of the OOK on symbol or the OOK off symbol.

The time duration length of the CAP may be independent of a time duration length of an OFDM symbol. Therefore, the CAP may not include CP. The D node may not consider CP and may estimate the chip duration of the OOK symbol of the PRDCH by measuring the duration of the OOK on symbol and/or the OOK off symbol. However, a total length of a time duration of the SIP and the CAP may be a multiple of a time duration length of an OFDM symbol (or, DFT or FFT size). In such a case, the D node may assume that the CAP duration does not include CP. In such a case, the total length of the SIP and the CAP may be configured to be a multiple of an OFDM symbol including CP. In other words, the time duration length of the SIP may be assumed to be configured longer than a time duration length of an OFDM symbol.

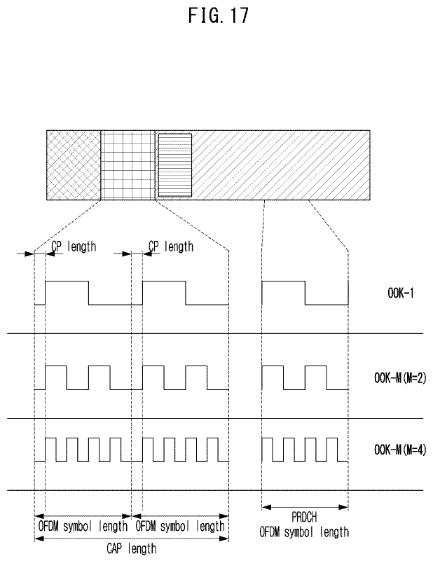

FIG. 17 is a conceptual diagram illustrating exemplary embodiments of a method for configuring a clock acquisition part.

Referring to FIG. 17, an R node may configure a CAP of an RD preamble with 2 single-bit chips having two CPs in a time duration of two OFDM symbols for a case where M is 1, for example. The CAP may have two rising edges and two falling edges. The R node may configure a CAP of an RD preamble with two single-bit chips having two CPs in a time duration of two OFDM symbols for a case where M is 2, for example. The CAP may have four rising edges and four falling edges. The R node may configure a CAP of an RD preamble with eight single-bit chips having two CPs in a time duration of two OFDM symbols for a case where M is 4, for example. The CAP may have eight rising edges and eight falling edges. As described above, the length of the CAP may be configured with two OFDM symbol lengths and may include a CP duration. The CP duration may be configured as an OOK off symbol or an OOK off pattern, for example.

A chip duration of two single-bit chips for a case where M=1 may be referred to as a first chip duration. A chip duration of four single-bit chips for a case where M=2 may be referred to as a second chip duration. A chip duration of eight single-bit chips for a case where M=4 may be referred to as a third chip duration. A length of the chip duration may decrease as M increases. The D node may receive the RD preamble including the CAP from the R node.

A time duration length of the CAP configured with two single-bit chips for a case where M=1 may be referred to as a first time duration. A time duration length of the CAP configured with four single-bit chips for a case where M=2 may be referred to as a second time duration. A time duration length of the CAP configured with eight single-bit chips for a case where M=4 may be referred to as a third time duration. The first time duration, the second time duration, and the third time duration may be identical. In other words, time lengths of the CAPs for various M may be identical. As M increases, a length of a pattern of two OOK on symbols and/or OOK off symbols may decrease and may be configured as a structure repeated M times.

The R node may configure the CAP including CP so that a time duration length of the CAP becomes a multiple of a time duration of an OFDM symbol. The R node may configure a CP duration of the CAP as an OOK off symbol. The R node may configure M OOK on symbols and/or OOK off symbols of the CAP, according to the chip duration of the OOK symbol of the PRDCH, in a time duration of the OFDM symbol excluding CP. The D node may assume a CP duration of the CAP after an endpoint of an SIP.

The D node may exclude CP durations of the two OFDM symbols and may determine the chip duration of the PRDCH or the value M of OOK-M from a transition interval of the OOK on symbol and the OOK off symbol of the CAP. Alternatively, the D node may exclude the CP durations of the two OFDM symbols and may estimate the chip duration of the PRDCH from a time duration length of the OOK on symbols and/or the OOK off symbols of the CAP. A time duration length of the OOK on symbol and a time duration length of the OOK off symbol may be identical. When the R node configures the time duration length of the OOK off symbol and the time duration length of the OOK on symbol differently for purposes such as CP duration processing, the D node may estimate the chip duration or the M value from a time duration length of one OOK symbol among the OOK on symbol and the OOK off symbol.

The time duration of the CAP may be independent of a time duration length of an OFDM symbol. Therefore, the CAP may not include CP. The D node may not consider CP and may estimate the chip duration of the OOK symbol of the PRDCH by measuring a time duration of the OOK on symbol and/or the OOK off symbol. However, a total length of a time duration of the SIP and the CAP may be a multiple of a time duration length of an OFDM symbol. In such a case, the D node may assume that the OFDM symbol of the PRDCH starts from after the time duration of the last OOK off symbol of the CAP. In other words, a time duration length of the SIP may be assumed to be configured longer than a time duration length of an OFDM symbol.

In a second exemplary embodiment, the R node may configure the on and off durations or chip durations of the CAP to be fixed regardless of M of the PRDCH. When M increases, the R node may configure the CAP as a structure repeating an on/off pattern having identical chip durations and may transmit the CAP to the D node. The R node may additionally configure a designated pattern or signal in the CAP in order to allow an endpoint of the CAP to be identified.

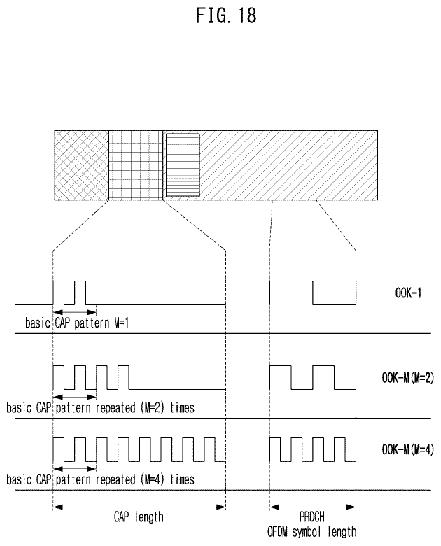

FIG. 18 is a conceptual diagram illustrating exemplary embodiments of a method for configuring a clock acquisition part.

Referring to FIG. 18, an R node may configure a basic CAP pattern. A first basic CAP pattern may be configured with an OOK on symbol and an OOK off symbol. A second basic CAP pattern may be configured with an OOK on symbol, an OOK off symbol, an OOK on symbol, and an OOK off symbol.

A time duration length of the OOK on symbol and the OOK off symbol of the basic CAP pattern may not match an OOK duration or chip duration of the PRDCH. The time duration length or duration of the OOK on symbol and the OOK off symbol may be configured as a time duration length of an OOK on symbol and an OOK off symbol corresponding to a maximum M value of OOK-M of the PRDCH.

The R node may configure a CAP of an RD preamble with one first basic CAP pattern or one second basic CAP pattern when M is 1, for example. The R node may configure a CAP of an RD preamble with two first basic CAP patterns or two second basic CAP patterns when M is 2, for example. The R node may configure a CAP of an RD preamble with four first basic CAP patterns or four second basic CAP patterns when M is 4, for example. The R node may configure a CAP of an RD preamble with eight first basic CAP patterns or eight second basic CAP patterns when M is 8, for example.

The R node may configure a CAP of an RD preamble with one first basic CAP pattern or one second basic CAP pattern when M is 1, for example. The R node may configure a CAP of an RD preamble with two first basic CAP patterns and two second basic CAP patterns when M is 2, for example. The R node may configure a CAP of an RD preamble with one first basic CAP pattern and three second basic CAP patterns when M is 4, for example. The R node may configure a CAP of an RD preamble with one first basic CAP pattern and seven second basic CAP patterns when M is 8, for example. As described above, the R node may configure the second basic CAP pattern when M is 1, and as M increases to 2, 3, etc., the R node may configure the first basic CAP pattern to increase by one in addition to the second basic CAP pattern, or configure the first basic CAP pattern to repeat in addition to the second basic CAP pattern.

The D node may receive the CAP from the R node. The D node may determine a repetition number of the basic CAP pattern of the received CAP. The D node may estimate M from the determined repetition number of the basic CAP pattern. The D node may estimate the chip duration from the estimated M. As described above, the basic CAP pattern may have a structure repeated M times according to M. The R node may configure the length of the CAP identically regardless of M. The D node may determine the chip duration of the PRDCH or the M value of the OOK-M from an on/off pattern of the CAP or a repetition number of the basic CAP pattern.

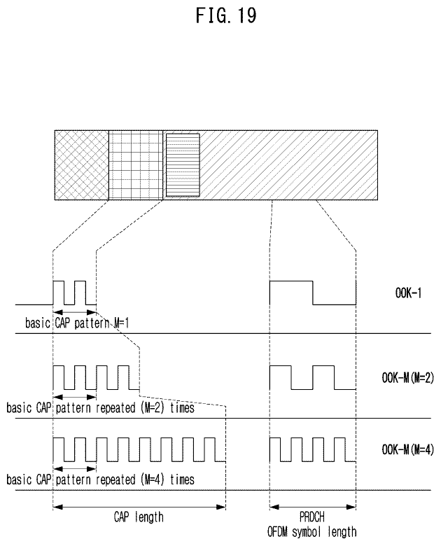

FIG. 19 is a conceptual diagram illustrating exemplary embodiments of a method for configuring a clock acquisition part.

Referring to FIG. 19, an R node may configure a basic CAP pattern. A first basic CAP pattern may be configured with an OOK on symbol and an OOK off symbol. Alternatively, a second basic CAP pattern may be configured with an OOK on symbol, an OOK off symbol, an OOK on symbol, and an OOK off symbol.

A time duration length of the OOK on symbol and the OOK off symbol of the basic CAP pattern may not match an OOK duration or chip duration of the PRDCH. A time duration length of the OOK on symbol and the OOK off symbol may be configured as a time duration length of an OOK on symbol and an OOK off symbol corresponding to a maximum M value of OOK-M of the PRDCH.

The R node may configure a CAP of an RD preamble with one first basic CAP pattern or one second basic CAP pattern when M is 1, for example. The R node may configure a CAP of an RD preamble with two first basic CAP patterns or two second basic CAP patterns when M is 2, for example. The R node may configure a CAP of an RD preamble with four first basic CAP patterns or four second basic CAP patterns when M is 4, for example. The R node may configure a CAP of an RD preamble with eight first basic CAP patterns or eight second basic CAP patterns when M is 8, for example.

The R node may configure a CAP of an RD preamble with one first basic CAP pattern or one second basic CAP pattern when M is 1, for example. The R node may configure a CAP of an RD preamble with two first basic CAP patterns and two second basic CAP patterns when M is 2, for example. The R node may configure a CAP of an RD preamble with one first basic CAP pattern and three second basic CAP patterns when M is 4, for example. The R node may configure a CAP of an RD preamble with one first basic CAP pattern and seven second basic CAP patterns when M is 8, for example. As described above, the R node may configure the second basic CAP pattern when M is 1, and as M increases to 2, 3, etc., the R node may configure the first basic CAP pattern to increase by one in addition to the second basic CAP pattern, or configure the first basic CAP pattern to repeat in addition to the second basic CAP pattern.

The D node may receive the CAP from the R node. The D node may determine a repetition number of the basic CAP pattern of the received CAP. The D node may estimate M from the determined repetition number of the basic CAP pattern. The D node may estimate the chip duration from the estimated M. As described above, the basic CAP pattern may have a structure repeated M times according to M. The R node may configure the CAP length also to be increased as M increases. The D node may determine the chip duration of the PRDCH or the M value of the OOK-M from an on/off pattern of the CAP or a repetition number of the basic CAP pattern.

In a third exemplary embodiment, a time duration of an OOK on symbol or a time duration of an on chip of the CAP may be fixed regardless of M of the PRDCH. In contrast, an off duration or an off chip duration may vary. An interval between two rising edges may be the same as a time duration of an OOK symbol or chip of the PRDCH. An interval between two falling edges may be the same as a time duration of an OOK symbol or chip of the PRDCH. In other words, the interval between two rising edges or the interval between two falling edges of the CAP may vary depending on M. The CAP may further include a designated pattern or signal to identify an end point of the CAP.

On the other hand, a time duration of an OOK on symbol or a time duration of an on chip of the CAP may vary regardless of M of the PRDCH. In contrast, an off duration or an off chip duration may be fixed. An interval between two rising edges may be the same as a time duration of an OOK symbol or chip of the PRDCH. An interval between two falling edges may be the same as a time duration of an OOK symbol or chip of the PRDCH. In other words, the interval between two rising edges or the interval between two falling edges of the CAP may vary depending on M. The CAP may further include a designated pattern or signal to identify an end point of the CAP.

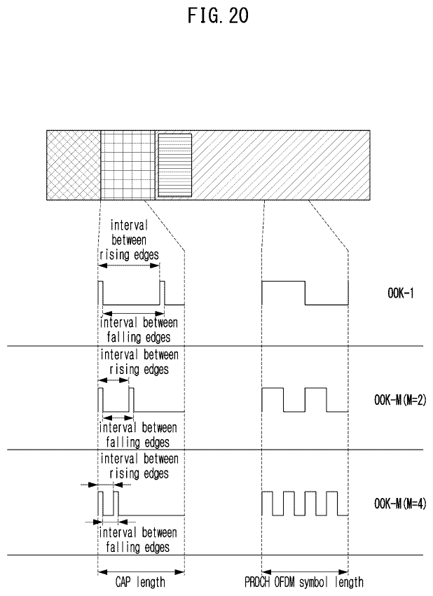

FIG. 20 is a conceptual diagram illustrating exemplary embodiments of a method for configuring a clock acquisition part.

Referring to FIG. 20, an R node may configure a CAP by using at least two OOK on symbols and at least two OOK off symbols in a time duration for the CAP of an RD transmission signal regardless of M. In other words, the R node may configure the CAP by using at least two on chips and at least two off chips in a time duration for the CAP of the RD transmission signal regardless of M. One of the at least two OOK on symbols may be arranged first in the time duration for the CAP. One of the at least two OOK off symbols may be arranged second in the time duration for the CAP. Another one of the at least two OOK on symbols may be arranged third in the time duration for the CAP. Another one of the at least two OOK off symbols may be arranged fourth in the time duration for the CAP.

The time duration length of the OOK on symbol or the time duration length of the on chip of the CAP may be fixed regardless of M of the PRDCH. The time durations of at least two on symbols configured within the CAP may have the same duration. The time duration of the OOK on symbol or the time duration of the on chip of the CAP may be configured shorter than the time duration of the on chip or OOK on symbol configured according to a largest value of M of OOK-M of the PRDCH. The time durations of at least two off symbols configured within the CAP may have different durations. The on durations of the CAP may be configured identically.

The CAP may have two rising edges and two falling edges. An interval between two rising edges may be the same as the time duration of the OOK symbol or chip of the PRDCH. An interval between two falling edges may be the same as the time duration of the OOK symbol or chip of the PRDCH. In other words, the interval between two rising edges or the interval between two falling edges of the CAP may vary depending on M. The interval between two rising edges of the CAP may be the same as the interval between two falling edges. The interval between two rising edges or the interval between two falling edges may vary depending on the OOK symbol duration or chip duration of the PRDCH.

When an SIP is terminated by an OOK off symbol, the CAP may start with a rising edge. The time duration for the CAP may always have a fixed length. The D node may receive the RD transmission signal including the CAP from the R node. The D node may obtain a time interval between at least two rising edges and at least two falling edges in the CAP of the received RD transmission signal. The D node may determine the time duration of the OOK symbol or chip of the PRDCH based on the obtained time interval between at least two rising edges and at least two falling edges in the CAP. The D node may determine an M value from the determined OOK symbol time duration or chip duration of the PRDCH.

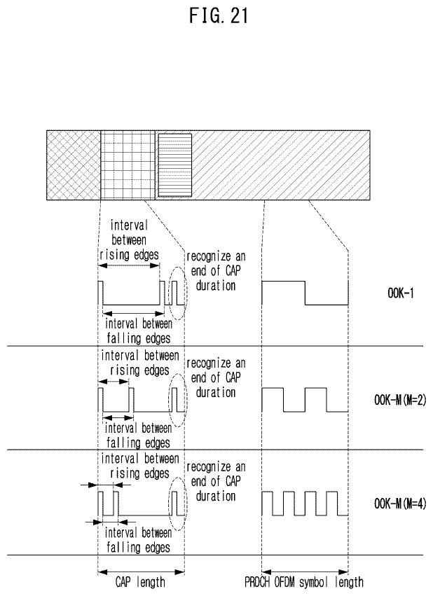

FIG. 21 is a conceptual diagram illustrating exemplary embodiments of a method for configuring a clock acquisition part.

Referring to FIG. 21, an R node may configure a CAP by using at least two OOK on symbols and at least two OOK off symbols in a time duration for the CAP of an RD transmission signal regardless of M. In other words, the R node may configure the CAP by using at least two on chips and at least two off chips in the time duration for the CAP of the RD transmission signal regardless of M. One of the at least two OOK on symbols may be arranged first in the time duration for the CAP. One of the at least two OOK off symbols may be arranged second in the time duration for the CAP. Another one of the at least two OOK on symbols may be arranged third in the time duration for the CAP. Another one of the at least two OOK off symbols may be arranged fourth in the time duration for the CAP.

The time duration length of the OOK on symbol or the time duration length of the on chip of the CAP may be fixed regardless of M of the PRDCH. The time durations of at least two on symbols configured within the CAP may have the same duration. The time duration of the OOK on symbol or the time duration of the on chip of the CAP may be configured shorter than the time duration of the on chip or OOK on symbol configured according to a largest value of M of OOK-K of the PRDCH. The time durations of at least two off symbols configured within the CAP may have different durations. The on durations of the CAP may be configured identically.

The CAP may have two rising edges and two falling edges. An interval between two rising edges may be the same as the time duration of the OOK symbol or chip of the PRDCH. An interval between two falling edges may be the same as the time duration of the OOK symbol or chip of the PRDCH. In other words, the interval between two rising edges or the interval between two falling edges of the CAP may vary depending on M. The interval between two rising edges of the CAP may be the same as the interval between two falling edges. The interval between two rising edges or the interval between two falling edges may vary depending on the OOK symbol duration or chip duration of the PRDCH.

When an SIP is terminated by an OOK off symbol, the CAP may start with a rising edge. The time duration for the CAP may always have a fixed length. The D node may receive the RD transmission signal including the CAP from the R node. The D node may obtain a time interval between at least two rising edges and at least two falling edges in the CAP of the received RD transmission signal. The D node may determine the time duration of the OOK symbol or chip of the PRDCH based on the obtained time interval between at least two rising edges and at least two falling edges in the CAP. The D node may determine an M value from the determined OOK symbol time duration or chip duration of the PRDCH.

The R node may additionally configure a designated pattern or signal for identifying the end time of the CAP so as to identify the end time of the CAP in the time duration for the CAP. The designated pattern or signal may be configured, for example, with at least one OOK on symbol and at least one OOK off symbol. The at least one OOK on symbol and the at least one OOK off symbol may be consecutive. In other words, the designated pattern or signal may be configured, for example, by using at least one on chip and at least one off chip. The at least one on chip and the at least one off chip may be consecutive. A time duration of at least one OOK on symbol and a time duration of at least one OOK off symbol may be the same.

The D node may receive the RD transmission signal including the CAP from the R node. The D node may identify the designated pattern or signal for identifying the end time of the CAP duration in the CAP of the received RD transmission signal. The designated pattern or signal for identifying the end time of the CAP duration may have the same time duration and may be at least one consecutive OOK on symbol and at least one consecutive OOK off symbol. When the designated pattern or signal for identifying the end time of the CAP duration is identified in the CAP, the D node may determine the end of the time duration for the CAP. As such, the R node may additionally configure the designated pattern or signal in the CAP so as to identify the end time of the CAP.

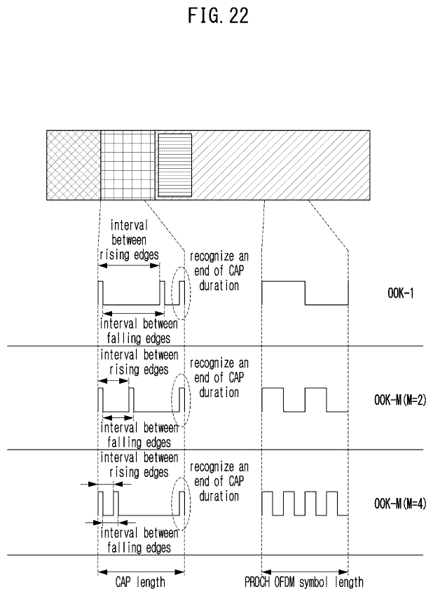

FIG. 22 is a conceptual diagram illustrating exemplary embodiments of a method for configuring a clock acquisition part.

Referring to FIG. 22, an R node may configure a CAP by using at least two OOK on symbols and at least two OOK off symbols in a time duration for the CAP of an RD transmission signal regardless of M. In other words, the R node may configure the CAP by using at least two on chips and at least two off chips in the time duration for the CAP of the RD transmission signal regardless of M. One of the at least two OOK on symbols may be arranged first in the time duration for the CAP. One of the at least two OOK off symbols may be arranged second in the time duration for the CAP. Another one of the at least two OOK on symbols may be arranged third in the time duration for the CAP. Another one of the at least two OOK off symbols may be arranged fourth in the time duration for the CAP.

The time duration length of the OOK on symbol or the time duration length of the on chip of the CAP may be fixed regardless of M of the PRDCH. The time durations of at least two on symbols configured within the CAP may have the same duration. The time duration of the OOK on symbol or the time duration of the on chip of the CAP may be configured shorter than a time duration of an on chip or a time duration of an OOK on symbol configured according to a largest value of M of OOK-M of the PRDCH. The time duration of at least two off symbols configured within the CAP may have different durations. The on durations of the CAP may be configured identically.

The CAP may have two rising edges and two falling edges. An interval between two rising edges may be the same as the time duration of the OOK symbol or chip of the PRDCH. An interval between two falling edges may be the same as the time duration of the OOK symbol or chip of the PRDCH. In other words, the interval between two rising edges or the interval between two falling edges of the CAP may vary depending on M. The interval between the two rising edges of the CAP may be the same as the interval between the two falling edges. The interval between the two rising edges or the interval between the two falling edges may vary depending on the OOK symbol duration or chip duration of the PRDCH.

When an SIP is terminated by an OOK off symbol, the CAP may start with a rising edge. The time duration for the CAP may always have a fixed length. The D node may receive the RD transmission signal including the CAP from the R node. The D node may obtain a time interval between at least two rising edges and at least two falling edges in the CAP of the received RD transmission signal. The D node may determine the time duration of the OOK symbol or chip of the PRDCH based on the obtained time interval between at least two rising edges and at least two falling edges in the CAP. The D node may determine an M value from the determined OOK symbol time duration or chip duration of the PRDCH.

The R node may additionally configure a designated pattern or signal for identifying the end time of the CAP so as to identify the end time of the CAP in the time duration for the CAP. The designated pattern or signal may be configured, for example, with at least one OOK on symbol.

The D node may receive the RD transmission signal including the CAP from the R node. The D node may identify the designated pattern or signal for identifying the end time of the CAP duration in the CAP of the received RD transmission signal. When the designated pattern or signal for identifying the end time of the CAP duration is identified in the CAP, the D node may determine the end of the time duration for the CAP.

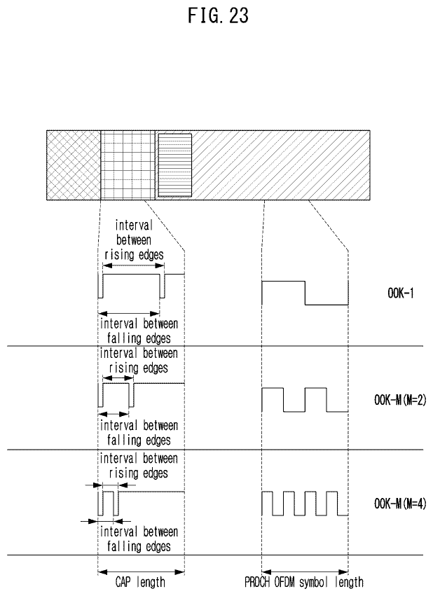

FIG. 23 is a conceptual diagram illustrating exemplary embodiments of a method for configuring a clock acquisition part.

Referring to FIG. 23, an R node may configure a CAP by using at least two OOK off symbols and at least two OOK on symbols in a time duration for the CAP of an RD transmission signal regardless of M. In other words, the R node may configure the CAP by using at least two off chips and at least two on chips in the time duration for the CAP of the RD transmission signal regardless of M. One of the at least two OOK off symbols may be arranged first in the time duration for the CAP. One of the at least two OOK on symbols may be arranged second in the time duration for the CAP. Another one of the at least two OOK off symbols may be arranged third in the time duration for the CAP. Another one of the at least two OOK on symbols may be arranged fourth in the time duration for the CAP.

The time duration length of the OOK off symbol or the time duration length of the off chip of the CAP may be fixed regardless of M of the PRDCH. The time durations of at least two off symbols configured within the CAP may have the same duration. The time duration of the OOK off symbol or the time duration of the off chip of the CAP may be configured shorter than a time duration of an off chip or a time duration of an OOK off symbol configured according to a largest value of M of OOK-M of the PRDCH. The time duration of at least two on symbols configured within the CAP may have different durations. The off durations of the CAP may be configured identically.

The CAP may have two rising edges and two falling edges. An interval between two rising edges may be the same as the time duration of the OOK symbol or chip of the PRDCH. An interval between two falling edges may be the same as the time duration of the OOK symbol or chip of the PRDCH. In other words, the interval between two rising edges or the interval between two falling edges of the CAP may vary depending on M. The interval between the two rising edges of the CAP may be the same as the interval between the two falling edges. The interval between the two rising edges or the interval between the two falling edges may vary depending on the OOK symbol duration or chip duration of the PRDCH.

When an SIP is terminated by an OOK on symbol, the CAP may start with a falling edge. The time duration for the CAP may always have a fixed length. The D node may receive the RD transmission signal including the CAP from the R node. The D node may obtain a time interval between at least two rising edges and at least two falling edges in the CAP of the received RD transmission signal. The D node may determine the time duration of the OOK symbol or chip of the PRDCH based on the obtained time interval between at least two rising edges and at least two falling edges in the CAP. The D node may determine an M value from the determined OOK symbol time duration or chip duration of the PRDCH.

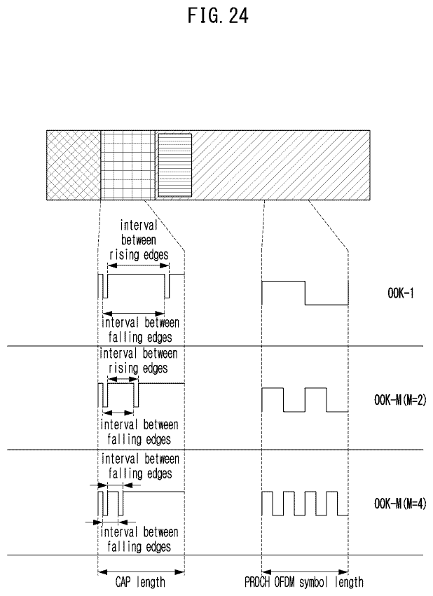

FIG. 24 is a conceptual diagram illustrating exemplary embodiments of a method for configuring a clock acquisition part.

Referring to FIG. 24, when an SIP is terminated by an OOK off symbol, the R node may additionally configure a designated pattern or signal for identifying a start time of a CAP duration that starts with a rising edge. The R node may additionally configure a designated pattern or signal for identifying the start time of the CAP so as to identify the start time of the CAP. The designated pattern or signal may be configured, for example, with at least one OOK on symbol. The D node may receive an RD transmission signal including the CAP from the R node. The D node may identify the designated pattern or signal for identifying the start time of the CAP duration in the CAP of the received RD transmission signal. The designated pattern or signal for identifying the start time of the CAP duration may be at least one OOK on symbol. When the designated pattern or signal for identifying the start time of the CAP duration is identified in the CAP, the D node may determine the start of the time duration for the CAP.

The R node may configure a CAP by using at least two OOK off symbols and at least two OOK on symbols in a time duration for the CAP of an RD transmission signal regardless of M. In other words, the R node may configure the CAP by using at least two off chips and at least two on chips in the time duration for the CAP of the RD transmission signal regardless of M. One of the at least two OOK off symbols may be arranged first in the time duration for the CAP. One of the at least two OOK on symbols may be arranged second in the time duration for the CAP. Another one of the at least two OOK off symbols may be arranged third in the time duration for the CAP. Another one of the at least two OOK on symbols may be arranged fourth in the time duration for the CAP.

The time duration of the OOK off symbol or the time duration of the off chip of the CAP may be fixed regardless of M of the PRDCH. The time durations of at least two off symbols configured within the CAP may have the same duration. The time duration of the OOK off symbol or the time duration of the off chip of the CAP may be configured shorter than a time duration of an off chip or a time duration of an OOK off symbol configured according to a largest value of M of OOK-M of the PRDCH. The time duration of at least two on symbols configured within the CAP may have different durations. The off durations of the CAP may be configured identically.

The CAP may have two rising edges and two falling edges. An interval between two rising edges may be the same as the time duration of the OOK symbol or chip of the PRDCH. An interval between two falling edges may be the same as the time duration of the OOK symbol or chip of the PRDCH. In other words, the interval between two rising edges or the interval between two falling edges of the CAP may vary depending on M. The interval between the two rising edges of the CAP may be the same as the interval between the two falling edges. The interval between the two rising edges or the interval between the two falling edges may vary depending on the OOK symbol duration or chip duration of the PRDCH.

The time duration for the CAP may always have a fixed length. The D node may receive the RD transmission signal including the CAP from the R node. The D node may obtain a time interval between at least two rising edges and at least two falling edges in the CAP of the received RD transmission signal. The D node may determine the time duration of the OOK symbol or chip of the PRDCH based on the obtained time interval between at least two rising edges and at least two falling edges in the CAP. The D node may determine an M value from the determined OOK symbol time duration or chip duration of the PRDCH.

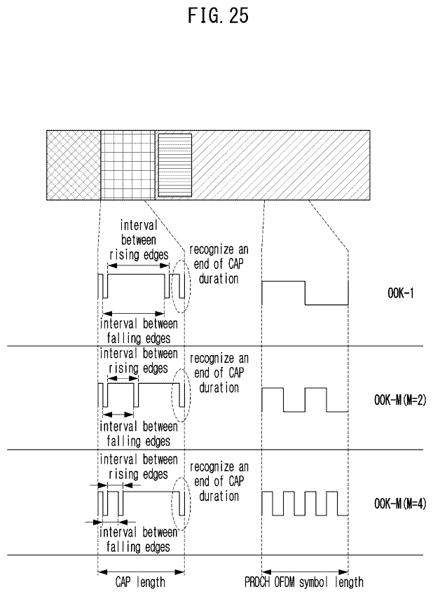

FIG. 25 is a conceptual diagram illustrating exemplary embodiments of a method for configuring a clock acquisition part.

Referring to FIG. 25, when an SIP is terminated by an OOK off symbol, the R node may additionally configure a designated pattern or signal for identifying a start time of a CAP duration, which starts with a rising edge. The R node may additionally configure a designated pattern or signal for identifying the start time of the CAP so as to identify the start time of the CAP. The designated pattern or signal may be configured, for example, with at least one OOK on symbol. The D node may receive an RD transmission signal including the CAP from the R node. The D node may identify the designated pattern or signal for identifying the start time of the CAP duration in the CAP of the received RD transmission signal. The designated pattern or signal for identifying the start time of the CAP duration may be at least one OOK on symbol. When the designated pattern or signal for identifying the start time of the CAP duration is identified in the CAP, the D node may determine the start of the time duration for the CAP.

The R node may configure a CAP by using at least two OOK off symbols and at least two OOK on symbols in the time duration for the CAP of the RD transmission signal regardless of M. In other words, the R node may configure the CAP by using at least two off chips and at least two on chips in the time duration for the CAP of the RD transmission signal regardless of M. One of the at least two OOK off symbols may be arranged first in the time duration for the CAP. One of the at least two OOK on symbols may be arranged second in the time duration for the CAP. Another one of the at least two OOK off symbols may be arranged third in the time duration for the CAP. Another one of the at least two OOK on symbols may be arranged fourth in the time duration for the CAP.

The time duration of the OOK off symbol or the time duration of the off chip of the CAP may be fixed regardless of M of the PRDCH. The time durations of at least two off symbols configured within the CAP may have the same duration. The time duration of the OOK off symbol or the time duration of the off chip of the CAP may be configured shorter than a time duration of an off chip or a time duration of an OOK off symbol configured according to a largest value of M of PRDCH OOK-M. The time duration of at least two on symbols configured within the CAP may have different durations. The off durations of the CAP may be configured identically.

The CAP may have two rising edges and two falling edges. An interval between two rising edges may be the same as the time duration of the OOK symbol or chip of the PRDCH. An interval between two falling edges may be the same as the time duration of the OOK symbol or chip of the PRDCH. In other words, the interval between two rising edges or the interval between two falling edges of the CAP may vary depending on M. The interval between the two rising edges of the CAP may be the same as the interval between the two falling edges. The interval between the two rising edges or the interval between the two falling edges may vary depending on the OOK symbol duration or chip duration of the PRDCH.

The time duration for the CAP may always have a fixed length. The D node may receive the RD transmission signal including the CAP from the R node. The D node may obtain a time interval between at least two rising edges and at least two falling edges in the CAP of the received RD transmission signal. The D node may determine the time duration of the OOK symbol or chip of the PRDCH based on the obtained time interval between at least two rising edges and at least two falling edges in the CAP. The D node may determine an M value from the determined OOK symbol time duration or chip duration of the PRDCH.

The R node may additionally configure a designated pattern or signal for identifying an end time of the CAP duration, which starts with a falling edge, in order to identify the end time of the CAP in the time duration for the CAP. The designated pattern or signal may be configured, for example, with at least one OOK off symbol. In other words, the designated pattern or signal may be configured, for example, by using at least one off chip.

The D node may receive the RD transmission signal including the CAP from the R node. The D node may identify the designated pattern or signal for identifying the end time of the CAP duration from the CAP of the received RD transmission signal. The designated pattern or signal for identifying the end time of the CAP duration may be at least one OOK off symbol having a falling edge. When the designated pattern or signal for identifying the end time of the CAP duration is identified from CAP, the D node may determine the end time of the time duration for the CAP.

In a fourth exemplary embodiment, a predetermined pattern may be configured according to M of the PRDCH. The predetermined pattern may be configured with rising edges and/or falling edges. For example, the predetermined pattern may be configured as ‘rising edge→falling edge→rising edge→falling edge’ with a chip duration period corresponding to M of the PRDCH.

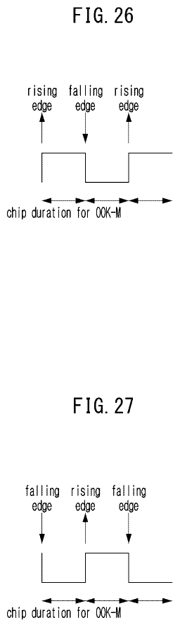

FIG. 26 is a conceptual diagram illustrating exemplary embodiments of a method for configuring a basic pattern for clock acquisition.

Referring to FIG. 26, an R node may configure a basic pattern or a basic signal for clock acquisition. The basic pattern or basic signal for clock acquisition may be a rectangular waveform or a pulse wave that repeats rise and fall with a chip duration period corresponding to M of the PRDCH. For example, the basic pattern or basic signal for clock acquisition may start at a low level and then rise to a high level, maintain the high level for the chip duration period corresponding to M of the PRDCH, then fall to the low level, maintain the low level for the chip duration period corresponding to M of the PRDCH, and then rise to the high level and maintain the high level for the chip duration period corresponding to M of the PRDCH.

In other words, the basic pattern or basic signal for clock acquisition may be configured according to M of the PRDCH. The basic pattern or basic signal for clock acquisition may be defined with a configuration of rising edges and/or falling edges. For example, the basic pattern or basic signal for clock acquisition may be a pattern or signal configured as ‘rising edge→falling edge→rising edge’ with a chip duration period corresponding to M of the PRDCH. The basic pattern of FIG. 26 may also be referred to as basic pattern 1.

FIG. 27 is a conceptual diagram illustrating exemplary embodiments of a method for configuring a basic pattern for clock acquisition.

Referring to FIG. 27, the R node may configure a basic pattern or a basic signal for clock acquisition. The basic pattern or basic signal for clock acquisition may be a rectangular waveform or a pulse wave that repeats fall and rise with a chip duration period corresponding to M of the PRDCH. For example, the basic pattern or basic signal for clock acquisition may start at a high level and then fall to a low level, maintain the low level for a chip duration period corresponding to M of the PRDCH, then rise to the high level, maintain the high level for the chip duration period corresponding to M of the PRDCH, and then fall to the low level and maintain the low level for the chip duration period corresponding to M of the PRDCH.

In other words, the basic pattern or basic signal for clock acquisition may be configured according to M of the PRDCH. The basic pattern or basic signal for clock acquisition may be defined with a configuration of falling edges and/or rising edges. For example, the basic pattern or basic signal for clock acquisition may be a pattern or signal configured as ‘falling edge→rising edge→falling edge’ with a chip duration period corresponding to M of the PRDCH. The basic pattern of FIG. 27 may be referred to as basic pattern 2.

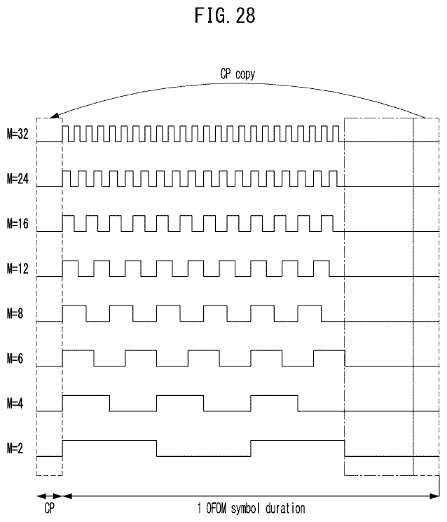

FIG. 28 is a conceptual diagram illustrating exemplary embodiments of a method for configuring a clock acquisition part.

Referring to FIG. 28, an R node may configure a CAP by using at least M/2 patterns according to OOK-M of the PRDCH in a time duration for the CAP (e.g. a time duration for one OFDM symbol). Among the M/2 patterns, an odd-numbered pattern may be a basic pattern, and an even-numbered pattern may be an opposite pattern of the basic pattern. A pattern CAP_P of the CAP may be as in Equation 1 or Equation 2 by using a basic pattern CAP_P(m). m may be a non-negative integer including 0, and M may be an integer of 2 or more.

$$CAP\_P = \{ CAP\_P ( 0 ) , - 1 \times CAP\_P ( 1 ) , … , CAP\_P ( m - 1 ) \} , m = 0 , 1 , … , ( M / 2 ) - 1 \qquad [ Equation l ]$$

$$CAP\_P = \{ {( - 1 )}^{m} \times CAP\_P ( m ) , … , {( - 1 )}^{m} \times CAP\_P ( m ) , m = 0 , 1 , … , ( M / 2 ) - 1 \qquad [ Equation 2 ]$$

The R node may maintain a remaining time duration at a low level after arranging the M/2 patterns in the time duration for the CAP (e.g. a time duration for one OFDM symbol). The R node may configure a CP to be located, on the time axis, before the time duration for the CAP (e.g. a time duration for one OFDM symbol). The D node may receive an RD transmission signal including the CAP from the R node. The D node may recognize that the pattern of the CAP starts after a CP of the CAP following an SIP.

The D node may obtain a time interval between at least two rising edges and at least two falling edges in the CAP of the received RD transmission signal. The D node may determine a time duration of an OOK symbol or chip of the PRDCH based on the obtained time interval between at least two rising edges and at least two falling edges in the CAP. The D node may determine an M value from the determined OOK symbol time duration or chip duration of the PRDCH.

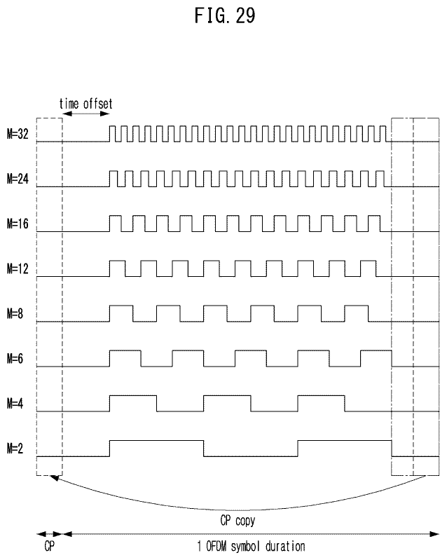

FIG. 29 is a conceptual diagram illustrating exemplary embodiments of a method for configuring a clock acquisition part.

Referring to FIG. 29, an R node may configure a CAP by using at least M/2 patterns according to OOK-M of the PRDCH after a time offset in a time duration for the CAP (e.g. a time duration for one OFDM symbol). Among the M/2 patterns, an odd-numbered pattern may be a basic pattern, and an even-numbered pattern may be an opposite pattern of the basic pattern. The time offset may be, for example, a chip duration corresponding to M=4 of the PRDCH.

The R node may maintain a remaining time duration at a low level or a high level after arranging the M/2 patterns in the time duration for the CAP (e.g. a time duration for one OFDM symbol). The R node may configure a CP to be located, on the time axis, before the time duration for the CAP (e.g. a time duration for one OFDM symbol). The D node may receive the RD transmission signal including the CAP from the R node. The D node may recognize that the pattern of the CAP starts after a CP of the CAP following an SIP. The D node may obtain a time interval between at least two rising edges and at least two falling edges in the CAP of the received RD transmission signal. The D node may determine a time duration of an OOK symbol or chip of the PRDCH based on the obtained time interval between at least two rising edges and at least two falling edges in the CAP. The D node may determine an M value from the determined OOK symbol time duration or chip duration of the PRDCH.

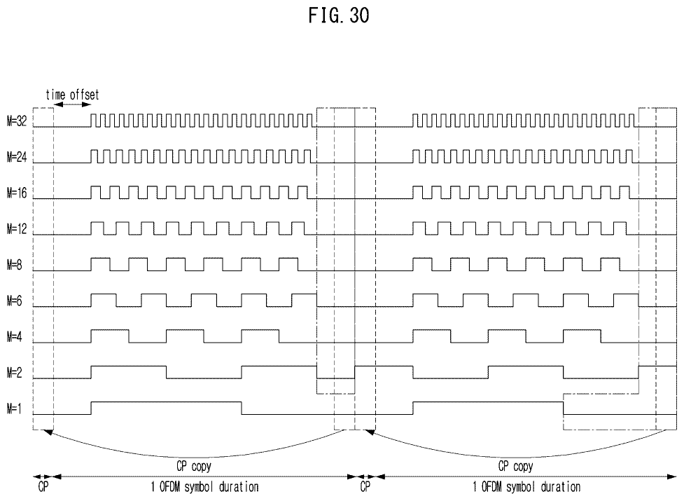

FIG. 30 is a conceptual diagram illustrating exemplary embodiments of a method for configuring a clock acquisition part.

Referring to FIG. 30, to support M of 1, an R node may configure a time duration for a CAP with time durations for two OFDM symbols. When M is 1, the R node may not configure a rising edge or a falling edge in a time duration for a CP that precedes the time durations for the two OFDM symbols. When M is 1, the R node may configure a continuous high-level state (e.g. on state) of an arbitrary length or a continuous low-level state (e.g. off state) of an arbitrary length to be maintained in the time duration for the CP that precedes the time durations for the two OFDM symbols.

When M is 2 or more, the R node may not configure a rising edge or a falling edge in each time duration for a CP that precedes each of the time durations for the two OFDM symbols. When M is 2 or more, the R node may configure a continuous high-level state of an arbitrary length or a continuous low-level state of an arbitrary length to be maintained in each time duration for the CP that precedes each of the time durations for the two OFDM symbols. As such, the R node may maintain a continuous high level or a continuous low level in the time duration for the CP and may enable no edge change in a CP duration for all values of M.

When M is 1, the R node may configure a CAP by using one basic pattern for OOK-1 in a time duration for the entire CAP, which is the time durations for the two OFDM symbols, after a time offset. When M is 2 or more, the R node may configure a CAP by using at least M/2 patterns according to OOK-M of the PRDCH after a time offset in each of the time durations for the two OFDM symbols. Among the M/2 patterns, an odd-numbered pattern may be a basic pattern, and an even-numbered pattern may be an opposite pattern of the basic pattern. The arbitrary time offset value may be, for example, a chip duration corresponding to M=4 of the PRDCH.

The R node may maintain a remaining time duration at a low level or a high level after arranging the M/2 patterns in each of the time durations for the two OFDM symbols. In other words, the R node may maintain the remaining time duration at a continuous low level of an arbitrary length or at a continuous high level of an arbitrary length after arranging the M/2 patterns in each of the time durations for the two OFDM symbols. The arbitrary length may be defined as a time length for an arbitrary time offset value.

The R node may configure a CP to be located, on the time axis, before the time duration for the CAP (e.g. a time duration for one OFDM symbol). The D node may receive the RD transmission signal including the CAP from the R node. The D node may recognize that the pattern of the CAP starts after a CP of the CAP following an SIP. The D node may obtain a time interval between at least two rising edges and at least two falling edges in the CAP of the received RD transmission signal. The D node may determine the time duration of the OOK symbol or chip of the PRDCH based on the obtained time interval between at least two rising edges and at least two falling edges in the CAP. The D node may determine an M value from the determined OOK symbol time duration or chip duration of the PRDCH.

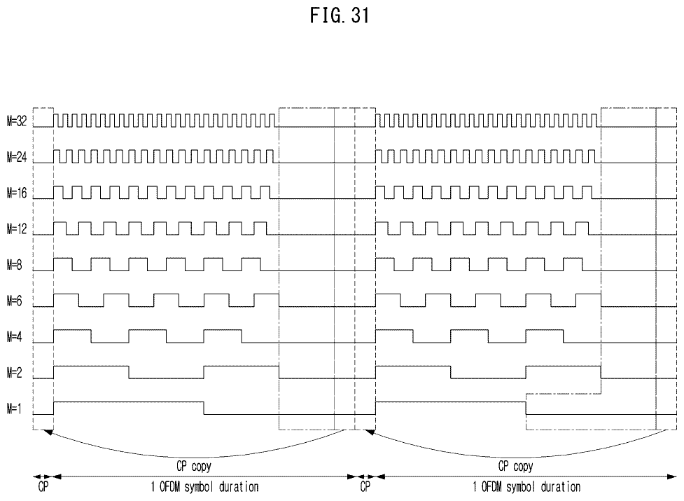

FIG. 31 is a conceptual diagram illustrating exemplary embodiments of a method for configuring a clock acquisition part.

Referring to FIG. 31, an R node may configure a time duration for a CAP for supporting M=1 with time durations for two OFDM symbols. When M is 1, the R node may not configure a rising edge or a falling edge in a time duration for a CP preceding the time durations for the two OFDM symbols. When M is 1, the R node may configure a continuous high-level state (e.g. on state) of an arbitrary length or a continuous low-level state (e.g. off state) of an arbitrary length to be maintained in the time duration for the CP that precedes the time durations for the two OFDM symbols.

When M is 2 or more, the R node may not configure a rising edge or a falling edge in each time duration for a CP that precedes each of the time durations for the two OFDM symbols. When M is 2 or more, the R node may configure a continuous high-level state of an arbitrary length or a continuous low-level state of an arbitrary length to be maintained in the time duration for the CP that precedes each of the time durations for the two OFDM symbols. As described above, the R node may maintain a continuous high level or a continuous low level in the time duration for the CP, and may enable no edge change in a CP duration for all values of M.

When M is 1, the R node may configure a CAP by using one basic pattern for OOK-1 in a time duration for the entire CAP, which is the time durations for the two OFDM symbols. When M is 2 or more, the R node may configure a CAP by using at least M/2 patterns according to OOK-M of the PRDCH in each of the time durations for the two OFDM symbols. Among the M/2 patterns, an odd-numbered pattern may be a basic pattern, and an even-numbered pattern may be an opposite pattern of the basic pattern.

The R node may maintain a remaining time duration at a low level or at a high level after arranging the M/2 patterns in each of the time durations for the two OFDM symbols. In other words, the R node may maintain the remaining time duration at a continuous low level of an arbitrary length or at a continuous high level of an arbitrary length after arranging the M/2 patterns in each of the time durations for the two OFDM symbols. The arbitrary length may be defined as a time length for an arbitrary time offset value.

The R node may configure a CP to be located, on the time axis, before the time duration for the CAP (e.g. a time duration for one OFDM symbol). The D node may receive the RD transmission signal including the CAP from the R node. The D node may recognize that the pattern of the CAP starts after a CP of the CAP following an SIP. The D node may obtain a time interval between at least two rising edges and at least two falling edges in the CAP of the received RD transmission signal. The D node may determine the time duration of the OOK symbol or chip of the PRDCH based on the time interval between the at least two rising edges and the at least two falling edges, which is obtained from the CAP. The D node may determine an M value from the determined OOK symbol time duration or chip duration of the PRDCH.

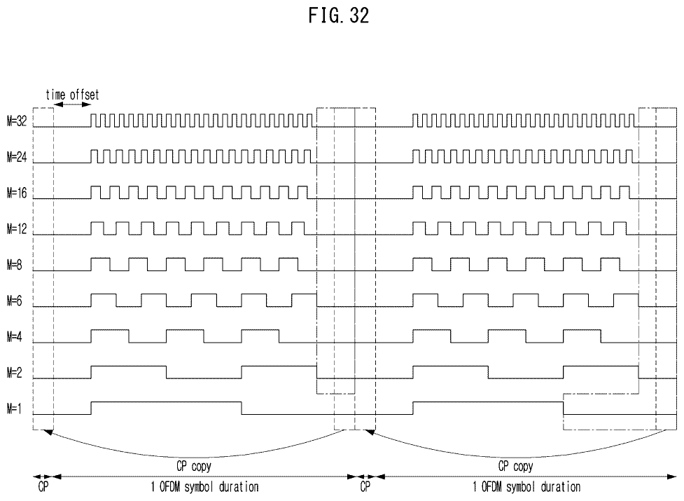

FIG. 32 is a conceptual diagram illustrating exemplary embodiments of a method for configuring a clock acquisition part.

Referring to FIG. 32, an R node may configure a time duration for a CAP for supporting M=1 as time durations for two OFDM symbols. When M is 1, the R node may not configure a rising edge or a falling edge in a time duration for a CP that precedes the time durations for the two OFDM symbols. When M is 1, the R node may configure a continuous high-level state (e.g. on state) of an arbitrary length or a continuous low-level state (e.g. off state) of an arbitrary length to be maintained in the time duration for the CP that precedes the time durations for the two OFDM symbols.

When M is 2 or more, the R node may not configure a rising edge or a falling edge in each time duration for a CP that precedes each of the time durations for the two OFDM symbols. When M is 2 or more, the R node may configure a continuous high-level state of an arbitrary length or a continuous low-level state of an arbitrary length to be maintained in the time duration for the CP that precedes each of the time durations for the two OFDM symbols. As described above, the R node may maintain a continuous high level or a continuous low level in the time duration for the CP, and may enable no edge change in a CP duration for all values of M.

When M is 1, the R node may configure a CAP by using one basic pattern for OOK-1 in a time duration for the entire CAP, which is the time durations for the two OFDM symbols, after a time offset. When M is 2 or more, the R node may configure a CAP by using at least M/2 patterns according to OOK-M of the PRDCH after a time offset in each of the time durations for the two OFDM symbols. Among the M/2 patterns, an odd-numbered pattern may be a basic pattern, and an even-numbered pattern may be an opposite pattern of the basic pattern. The arbitrary time offset value may be, for example, a chip duration corresponding to M=4 of the PRDCH.

The R node may configure a CP to be located, on the time axis, before the time duration for the CAP (e.g. a time duration for one OFDM symbol). The D node may receive the RD transmission signal including the CAP from the R node. The D node may recognize that the pattern of the CAP starts after a CP of the CAP following an SIP. The D node may obtain a time interval between at least two rising edges and at least two falling edges in the CAP of the received RD transmission signal. The D node may determine the time duration of the OOK symbol or chip of the PRDCH based on the time interval between the at least two rising edges and the at least two falling edges, which is obtained in the CAP. The D node may determine an M value from the determined OOK symbol time duration or chip duration of the PRDCH.

### [Regarding a DR Transmission of a CAP]

The R node may transmit a CAP including information on a structure of a DR transmission signal or chip information to the D node. The D node may receive the CAP including the structure of the DR transmission signal or the chip information. The D node may obtain the signal structure, the chip information, and the like from the obtained CAP. As described above, as another usage of the CAP, the R node may configure a signal so that the D node may obtain the structure of the DR transmission signal or the chip information.

### [Additional Definition Requirements of a CAP]

A time duration length of a CAP may be a time duration length of at least one OFDM symbol or a time duration length of at least one OFDM symbol including at least one CP. Alternatively, the time duration length of the CAP may be a multiple of a time duration length of at least one OFDM symbol or a multiple of a time duration length of at least one OFDM symbol including at least one CP.

The time duration length of an SIP and the CAP may be a time duration length of at least one OFDM symbol or a time duration length of at least one OFDM symbol including at least one CP. Alternatively, the time duration length of the SIP and the CAP may be a multiple of a time duration length of at least one OFDM symbol or a multiple of a time duration length of at least one OFDM symbol including at least one CP.

### [DR Transmission]

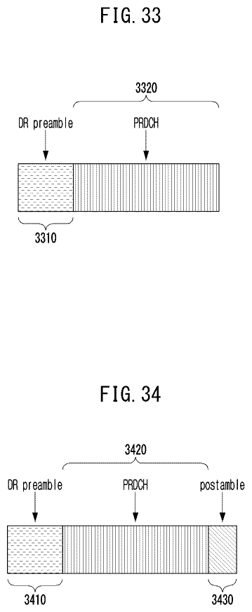

FIG. 33 is a conceptual diagram illustrating exemplary embodiments of a signal transmitted from a D node to an R node.

Referring to FIG. 33, a signal transmitted from a D node to an R node may include a DR preamble 3310 for indicating a start of a DR transmission signal and a PDRCH 3320. The R node may utilize the DR preamble for receiving the DR transmission signal. The D node may transmit data or higher-layer data desired to be transmitted to the R node through the PDRCH. For example, the D node may transmit data or higher-layer data desired to be transmitted to the R node through the PDRCH by configuring the data with OOK symbols or binary phase-shift keying (BPSK) symbols. The R node may receive the PDRCH including the data or the higher-layer data desired to be transmitted from the D node, and may obtain the data or the higher-layer data desired to be transmitted from the D node from the received PDRCH.

FIG. 34 is a conceptual diagram illustrating exemplary embodiments of a signal transmitted from a D node to an R node.

Referring to FIG. 34, a signal transmitted from a D node to an R node may include a DR preamble 3410, a PDRCH 3420, and a postamble 3430. The postamble may be defined as a type of midamble. The D node may transmit data or higher-layer data desired to be transmitted to the R node through the PDRCH. For example, the D node may transmit the data or higher-layer data desired to be transmitted to the R node through the PDRCH by configuring the data or higher-layer data with at least OOK symbols or BPSK symbols. The R node may receive the PDRCH including the data or higher-layer data desired to be transmitted from the D node, and the R node may obtain the data or higher-layer data desired to be transmitted from the received PDRCH.

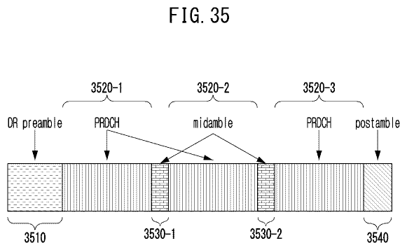

FIG. 35 is a conceptual diagram illustrating exemplary embodiments of a signal transmitted from a D node to an R node.

Referring to FIG. 35, a signal transmitted from a D node to an R node may include a DR preamble 3510, PDRCHs 3520-1 and 3520-2, midambles 3530-1 and 3530-2, and a postamble 3540. The postamble may be defined as a type of midamble. The DR preamble may be configured as an arbitrary binary sequence. The D node may transmit data or higher-layer data desired to be transmitted to the R node through the PDRCH. For example, the D node may transmit the data or higher-layer data desired to be transmitted to the R node through the PDRCH by configuring the data or higher-layer data with at least OOK symbols or BPSK symbols. The R node may receive the PDRCH including the data or higher-layer data desired to be transmitted from the D node, and the R node may obtain the data or higher-layer data desired to be transmitted from the received PDRCH.

Referring to FIGS. 33 to 35, each DR transmission signal may include the DR preamble configured as a binary sequence at a foremost portion so that the R node is able to utilize the DR preamble for receiving the DR transmission signal. The DR transmission signal may include, for example, A midambles and optionally one postamble. A may be a positive integer. The A midambles may be located between the PDRCHs. The postamble may be defined as a type of midamble. The D node may deliver data or higher-layer data desired to be delivered to the R node through the PDRCH in addition to the preamble and/or the midamble and/or the postamble. The D node may configure the data in the PDRCH with at least OOK symbols or BPSK symbols and may transmit the data to the R node.

The R node may transmit information on a structure of the DR transmission signal to the D node. The D node may receive information on the structure of the DR transmission signal from the R node. Regarding the structure of the DR transmission signal, the R node may transmit a condition for determining the structure of the DR transmission signal or information for determining the structure of the DR transmission signal for each D node to the D node as a higher-layer message (e.g. radio resource control (RRC) message). The D node may receive the condition for determining the structure of the DR transmission signal or information for determining the structure of the DR transmission signal for each D node from the R node through the higher-layer message (e.g. RRC message).

The R node may configure information indicated by conditions for determining a structure of the DR transmission signal as a table. The R node may transmit information regarding the table to the D node. The D node may receive information regarding the table from the R node. The R node may deliver the conditions as RD control information to the D node. The D node may receive the conditions as RD control information from the R node. The D node may determine the structure of the DR transmission signal using information for determining the structure of the DR transmission signal in the table indicated by the received conditions. As described above, the R node may dynamically indicate, to the D node, a transmission structure to be used for the DR transmission signal through the RD control information.

The R node may generate RD control information including information on a structure of the DR transmission signal. The R node may transmit a PRDCH including the RD control information to the D node. The D node may receive the PRDCH including the RD control information from the R node, and the D node may obtain the RD control information from the received PRDCH. The D node may obtain information on the structure of the RD transmission signal from the RD control information, and the D node may determine the structure of the DR transmission signal using the obtained information on the structure of the DR transmission signal. As described above, the R node may indicate, to the D node, the structure of the DR transmission signal through the PRDCH including the information on the structure of the DR transmission signal.

The R node may deliver a pattern or sequence of a CAP reflecting information on the structure of the DR transmission signal to the D node. The D node may receive the pattern or sequence of the CAP reflecting information on the DR transmission signal structure from the R node. The D node may obtain information on the RD transmission signal structure from the pattern or sequence of the CAP, and the D node may determine the DR transmission signal structure using the obtained information on the DR transmission signal structure. As described above, the R node may indicate, to the D node, information on the DR transmission signal structure through the pattern or sequence of the CAP of the RD transmission signal. The R node may indicate, to the D node, information on the DR transmission signal structure by using a combination of the information transmission methods described above.

In a first exemplary embodiment, the R node may transmit RD control information including information regarding the DR transmission signal structure to the D node. The D node may receive the RD control information from the R node. The D node may obtain information regarding the DR transmission signal structure from the RD control information. The D node may configure the DR transmission signal according to the obtained information regarding the DR transmission signal structure, and the D node may transmit the configured DR transmission signal to the R node. As described above, the R node may indicate, to the D node, the DR transmission signal structure through the RD control information.

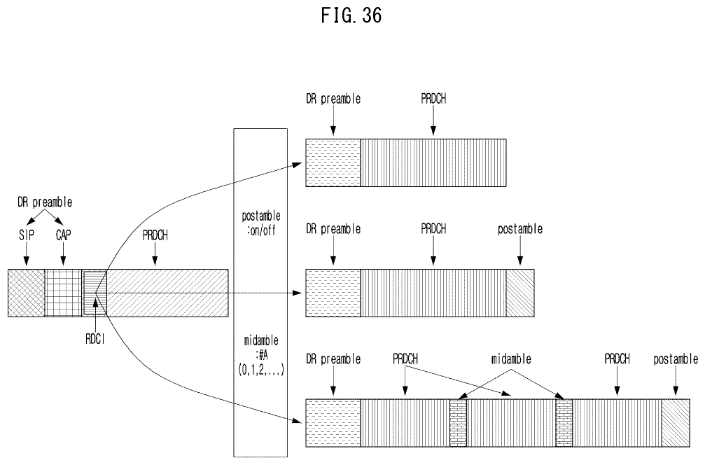

FIG. 36 is a conceptual diagram illustrating exemplary embodiments of a method for delivering structure information of a signal transmitted from a D node to an R node.

Referring to FIG. 36, an R node may transmit RD control information including information regarding a DR transmission signal structure to a D node. The D node may receive the RD control information from the R node. The D node may obtain information regarding the DR transmission signal structure from the RD control information. The D node may configure a DR transmission signal according to the obtained information regarding the DR transmission signal structure, and the D node may transmit the configured DR transmission signal to the R node. As described above, the R node may indicate, to the D node, the DR transmission signal structure through the RD control information.

The R node may transmit the RD control information including information regarding whether or not to configure midamble(s) in the DR transmission signal and/or information regarding how many midambles are configured to the D node. The D node may receive the RD control information from the R node. The D node may obtain information regarding whether or not to configure midamble(s) in the DR transmission signal and/or information regarding how many midambles are configured from the RD control information. The D node may configure midamble(s) in the DR transmission signal according to information regarding whether or not to configure midamble(s) and/or how many midambles are configured, and the D node may transmit the DR transmission signal including the configured midamble(s) to the R node.

The R node may generate RD control information including information regarding a periodicity or position for configuring midamble(s) in the DR transmission signal. The R node may transmit the RD control information to the D node. The D node may receive the RD control information from the R node. The D node may obtain information regarding the periodicity or position for configuring the midamble(s) in the DR transmission signal from the RD control information. The D node may configure the midamble(s) in the DR transmission signal according to the obtained information regarding the periodicity or position for configuring the midamble(s), and the D node may transmit the DR transmission signal including the configured midamble(s) to the R node.

The periodicity or position information may be expressed by at least one of a number of chips, a number of symbols, or a number of transmission bits of the DR transmission signal. At least one of the number of chips, the number of symbols, or the number of transmission bits may be referred to as an interval size. For example, the interval size may be expressed as N_Int_midamble. The R node may generate RD control information including N_Int_midamble. The R node may transmit the RD control information to the D node. The D node may receive the RD control information from the R node. The D node may obtain N_Int_midamble from the RD control information. The D node may configure the midambles in the DR transmission signal according to the obtained N_Int_midamble, and the D node may transmit the DR transmission signal including the midambles to the R node. As described above, the R node may instruct the D node to configure the midambles in the DR transmission signal using the interval size expressed as N_Int_midamble. The interval size may be defined by one or more values. When the interval size is defined by the number of transmission bits, the interval size may be simply expressed as a bit size.

The R node may generate RD control information including an information field indicating a midamble interval size value (e.g. bit size). The R node may transmit the RD control information to the D node. The D node may receive the RD control information from the R node. The D node may acquire the midamble interval size value from the RD control information. The D node may configure midambles in a DR transmission signal according to the acquired midamble interval size value, and may transmit the DR transmission signal including the configured midambles to the R node. In this manner, the R node may instruct the D node to configure the midambles in the DR transmission signal by including the information field indicating the midamble interval size value (e.g. bit size) in the RD control information.

The R node may include a condition of not configuring midamble(s) in the information field and may transmit the information field to D node. The D node may acquire the condition of not configuring midamble(s) from the information field, and may not configure midamble(s) according to the acquired condition.

The bit size value indicated by the information field may represent the number of bits including block repetitions for the information data of the DR transmission signal. Alternatively, the bit size value indicated by the information field may represent the number of bits after channel encoding. A physical or actual time interval may be different according to a chip duration or a bit duration of the DR transmission signal, for the bit size value indicating the interval size of the midamble.

For example, the D node may apply Manchester coding to the DR transmission signal. In this case, two chips may be configured for one bit. When a chip duration is 133.33 us, a bit duration may be 266.66 us. The bit size for configuring a midamble every 20 ms in the DR transmission signal may be 75, the bit size for configuring a midamble every 40 ms in the DR transmission signal may be 150, and the bit size for configuring a midamble every 80 ms in the DR transmission signal may be 300.

Alternatively, a chip duration may be 66.67 us. In this case, the bit size for configuring a midamble every 20 ms in the DR transmission signal may be 150, the bit size for configuring a midamble every 40 ms in the DR transmission signal may be 300, and the bit size for configuring a midamble every 80 ms in the DR transmission signal may be 600.

Accordingly, in order for the R node to schedule or instruct the D node to configure midambles at the same physical time interval for different chip durations, the R node may instruct the D node to configure midambles using different bit sizes for different chip durations. For example, the R node may define a representative chip duration or a representative bit duration. The representative chip duration or the representative bit duration may be defined as the longest chip or bit duration. The R node may transmit information on the representative chip duration or the representative bit duration to the D node. The D node may receive the information on the representative chip duration or the representative bit duration from the R node and may store and manage the information.

The R node may define N representative bit size values. For example, the R node may define the N representative bit size values based on the representative chip duration or the representative bit duration. The N representative bit size values may be P_N_Int_midamble(0), P_N_Int_midamble(1), . . . , and P_N_Int_midamble(N−1). In other words, the representative bit size value may be expressed as P_N_Int_midamble(n), and n may be 0, 1, . . . , N−1. N may be a positive integer. The R node may transmit information on the N representative bit size values to the D node. The D node may receive the information on the N representative bit size values from the R node and may store and manage the N representative bit size values. The R node may determine bit size values for chip durations or bit durations other than the representative chip duration or the representative bit duration using Equations 3 to 5 below. The bit size values for chip durations or bit durations other than the representative chip duration or the representative bit duration may be N_Int_midamble(0), N_Int_midamble(1), . . . , and N_Int_midamble(N−1). In other words, the bit size value may be expressed as N_Int_midamble(n), and n may be 0, 1, . . . , N−1. N may be a positive integer.

$$N\_Int \_midamble ( n ) = \{ [ N\_Int \_midamble ( 0 ) , N\_Int \_midamble ( 1 ) , … , N\_Int \_midamble ( N - 1 ) ] \times ( ( representative chip duration or representative bit duration ) / ( chip duration or bit duration ) ) \} \qquad [ Equation 3 ]$$

$$Ceiling \{ N\_Int \_midamble ( n ) \} = Ceiling \{ N\_Int \_midamble ( 0 ) , N\_Int \_midamble ( 1 ) , … , N\_Int \_midamble ( N - 1 ) ] \times ( ( representative chip duration or representative bit duration ) / ( chip duration or bit duration ) ) \} \qquad [ Equation 4 ]$$

$$floor \{ N\_Int \_midamble ( n ) \} = floor \{ N\_Int \_midamble ( 0 ) , N\_Int \_midamble ( 1 ) , … , N\_Int \_midamble ( N - 1 ) ] \times ( ( representative chip duration or representative bit duration ) / ( chip duration or bit duration ) ) \} \qquad [ Equation 5 ]$$

The R node may determine a bit size value to be indicated to the D node based on the chip duration or bit duration of the D node. The R node may convert the determined bit size value into a representative bit size value based on Equations 3 to 5. The R node may transmit the converted representative bit size value to the D node. The D node may receive the converted representative bit size value from the R node.

The D node may determine the bit size value from the received representative bit size value using Equations 3 to 5. The D node may configure midambles in the DR transmission signal using the determined bit size value, and may transmit the DR transmission signal including the midambles to the R node. In this manner, the R node may first define the bit size for the representative chip duration or the representative bit duration, and may indicate or use bit sizes proportionally for other chip durations. The D node may determine a bit size for configuring midambles according to Equations 3 to 5 from the bit size information related to the midamble interval indicated by the RD control information and the chip duration or the bit duration information of the DR transmission signal and may configure the midambles.

The R node may define that the bit size in the RD control information field means a different bit size value for each chip duration or bit duration. In other words, the R node may allow each D node to configure midambles in the DR transmission signal with a different time duration for each chip duration or bit duration of each D node with respect to the bit size in the RD control information field. In this case, the D node may configure the midamble in the DR transmission signal with a different physical time duration for each chip duration or bit duration. The R node may transmit the RD control information including the information for the bit size to the D node. The D node may acquire the information on the bit size for the interval of the midamble from the RD control information.

The D node may determine a time interval for configuring midambles based on the information on the bit size for the interval of midambles acquired from the RD control information and information on the chip duration or bit duration of the DR transmission signal. The D node may configure the midambles in the DR transmission signal according to the determined time interval and may transmit the DR transmission signal including the midambles to the R node. The R node may define the bit size value for the interval of the midambles in consideration of different length conditions of the midamble and/or chip duration (or bit duration).

For example, the information field may be configured with 2 bits. The information field may configure four conditions. One condition (e.g. 00) among the four conditions may be a condition in which midambles are not configured. Another condition (e.g. 01) among the four conditions may be a condition for configuring the midambles at a time interval of 20 ms for all chip durations of the DR transmission signal. The representative chip duration may be assumed as the longest 133.33 us. In this case, another condition may mean 75 bit units. Another condition (e.g. 10) among the four conditions may be a condition for configuring the midambles at a time interval of 40 ms for all chip durations of the DR transmission signal. The representative chip duration may be assumed as the longest 133.33 us. In this case, another condition may mean 150 bit units. Another condition (e.g. 11) among the four conditions may be a condition for configuring the midambles at a time interval of 80 ms for all chip durations of the DR transmission signal. The representative chip duration may be assumed as the longest 133.33 us. In this case, another condition may mean 300 bit units.

The R node may transmit RD control information including information indicating whether to configure a postamble in a DR transmission signal to the D node. The D node may receive the RD control information including information indicating whether to configure a postamble in a DR transmission signal from the R node. The D node may identify whether to configure a postamble in a DR transmission signal from the RD control information. When the D node identifies that a postamble is to be configured, the D node may transmit a DR transmission signal including a postamble to the R node.

The postamble may be regarded as a type of midamble as described above. Strictly speaking, the postamble may differ from a midamble because the postamble is located at the end of the DR transmission signal. In the DR transmission signal, a considerable number of bits may remain after transmission of the last midamble until the end of the DR transmission signal, due to the limited number and bit size of the midambles. In such a case, the D node may additionally configure a midamble (or postamble).

The R node may transmit RD control information including indication information instructing the D node to configure an additional midamble at the end of the DR transmission signal, separately from the configuration of midambles with the same interval, to the D node. The D node may receive the RD control information including indication information instructing the D node to configure an additional midamble at the end of the DR transmission signal, separately from the configuration of midambles with the same interval, from the R node. The D node may configure an additional midamble at the end or the last part of the DR transmission signal according to the received indication information.

As described above, the R node may indicate, to the D node, whether to additionally configure an additional midamble at the end of the DR transmission signal, separately from the configuration of midambles with the same interval. The D node may configure midambles at equal intervals after the DR preamble according to the midamble configuration condition or configuration bit interval. When the RD control information includes indication information for additionally configuring a midamble at the end of the DR transmission signal, the D node may additionally configure a midamble at the end or the last part of the DR transmission signal regardless of the equal interval.

In a second exemplary embodiment, the midamble and/or postamble may be configured according to the size of data included in the DR transmission signal or a time length of the DR transmission signal. The D node may determine to configure the midamble and/or postamble in the DR transmission signal according to the size of data included in the DR transmission signal or the time length of the DR transmission signal. The determination of the D node may be based on conditions defined in the technical specifications. Alternatively, the R node may provide, through an RRC message (i.e. higher-layer control information), to the D node a configuration method of the midamble and/or postamble according to conditions such as the data size of the DR transmission signal and/or the DR transmission OOK symbol chip duration and/or the type of D node and/or an arbitrary DR configuration scheme. The D node may receive, through the RRC message, the configuration method of the midamble and/or postamble, and may configure the midamble and/or postamble in the DR transmission signal according to the received configuration method of the midamble and/or postamble. As such, the D node may configure the midamble and/or postamble of the DR transmission signal according to the configuration method for the corresponding condition for the DR transmission scheduled by the R node.

In a third exemplary embodiment, the midamble and/or postamble may be determined in consideration of the chip duration of the PDRCH. For example, when the chip duration is long, a clock error for the same information bit may occur largely in the latter part of the DR transmission signal. The corresponding condition may be predefined in the technical specifications. Alternatively, the R node may provide, through an RRC message (i.e. higher-layer control information), to the D node a configuration method of the midamble and/or postamble according to the DR transmission OOK symbol chip duration. The D node may receive, through the RRC message, the configuration method of the midamble and/or postamble, and may configure the midamble and/or postamble in the DR transmission signal according to the received configuration method of the midamble and/or postamble. As such, the D node may configure the midamble and/or postamble of the DR transmission signal according to the configuration method for the corresponding condition for the DR transmission signal scheduled by the R node.

In a fourth exemplary embodiment, the midamble may be configured through DR transmission repetition. The DR transmission signal may be repeatedly transmitted in block units for transmission data or transmission information. The number of repetitions of the repeated transmission may be expressed as DR_N_Rep. The midamble may be configured at the end of each repetition of the DR transmission signal in the repeated transmission. The PDRCH may be configured after the DR preamble. The PDRCH may be repeatedly configured. The midamble may be configured whenever the repeated block of the PDRCH ends. In such a case, the midamble configured in the block where the last repetition ends may be configured as the last midamble of the entire DR transmission signal. In another exemplary embodiment, the D node may determine a structure of the DR transmission signal through a combination of the above examples and may configure the DR transmission signal according to the determined structure.

The present disclosure describes in more detail the configuration of the midamble(s) of the DR transmission signal based on exemplary embodiments and methods for the DR transmission signal structure. The amble (or postamble) configured at the end of the DR transmission signal may be assumed as one of the midambles.

For example, the D node may determine whether to configure midamble(s) based on at least one of information bit size, chip duration, convolutional channel coding rate, DR repetition, midamble configuration factor, or control information. The D node may determine a midamble configuration position based on at least one of information bit size, chip duration, convolutional channel coding rate, DR repetition, midamble configuration factor, or control information. The D node may determine a midamble duration based on at least one of information bit size, chip duration, convolutional channel coding rate, DR repetition, midamble configuration factor, or control information.

The channel coding rate CR may be 1 when channel coding is not applied. The DR repetition R may be 1 when no repetition transmission is performed for the DR transmission signal and a single transmission is performed. The chip duration may correspond to the OOK-M of the RD transmission signal. The information bit size may be expressed as N_Bit. The reference information bit size may be expressed as Ref_N_Bit. For example, the R node may define the reference information bit size. The R node may include information on the defined reference information bit size in RD control information and transmit it to the D node. The D node may receive information on the reference information bit size from the R node and store and manage the information. The reference chip duration may be expressed as Ref_ChipDur.

The R node may define a reference chip duration. The reference chip duration may be a maximum M value applicable to the DR transmission signal. The R node may include information on the defined reference chip duration in RD control information and transmit it to the D node. The D node may receive information on the reference chip duration from the R node and store and manage the information. A transmission length (or transmission time) of Ref_N_Bit considering Ref_ChipDur may be defined as a basic unit for configuring a midamble. The D node may determine a basic number of midambles Cal_N_midamble related to the midamble configuration by using Equations 6 to 8 below. The chip duration of the DR transmission signal may be expressed as DR_ChipDur.

$$Cal\_N \_midamble = [ N\_Bit \times ( Ref\_ChipDur / DR\_ChipDur ) \times ( 1 / CR ) \times R ] / [ Ref\_N \_Bit ] \qquad [ Equation 6 ]$$

$$Cal\_N \_midamble = [ N\_Bit \times ( Ref\_ChipDur / DR\_ChipDur ) \times ( 1 / CR ) ] / [ Ref\_N \_Bit ] \qquad [ Equation 7 ]$$

$$Cal\_N \_midamble = [ N\_Bit \times ( Ref\_ChipDur / DR\_ChipDur ) \times R ] / [ Ref\_N \_Bit ] \qquad [ Equation 8 ]$$

$$Cal\_N \_midamble = [ N\_Bit \times ( Ref\_ChipDur / DR\_ChipDur ) ] / [ Ref\_N \_Bit ] \qquad [ Equation 9 ]$$

The R node may transmit a PDRCH including control information for PDRCH scheduling, including at least one of information bit size, chip duration of the DR transmission signal, channel coding rate, or DR repetition, to the D node. The D node may receive, through the PDRCH, control information for PDRCH scheduling including at least one of information bit size, chip duration of the DR transmission signal, channel coding rate, or DR repetition, from the R node. The D node may determine the number of midambles N_midamble from Cal_N_midamble of Equations 6 to 9 as shown in Equations 10 to 12.

$$N\_midamble = floor ( Cal\_N \_midamble ) \qquad [ Equation 10 ]$$

$$N\_midamble = ceiling ( Cal\_N \_midamble ) \qquad [ Equation 11 ]$$

$$N\_midamble = int ( Cal\_N \_midamble ) \qquad [ Equation 12 ]$$

The D node may determine N_midamble as an integer value greater than Cal_N_midamble. The D node may determine N_midamble as an integer value smaller than Cal_N_midamble. The D node may configure midambles in a DR transmission signal in consideration of the determined N_midamble.

For example, the D node may divide the total transmission time of the DR transmission signal by N_midamble to form N_midamble DR transmission units. The D node may configure a midamble in each of the formed N_midamble DR transmission units (or after each DR transmission unit). The N_midamble DR transmission units may have the same transmission time. When the total transmission time of the DR transmission signal cannot be divided equally, the last DR transmission unit may have a transmission time different from other DR transmission units.

For example, the D node may divide the total transmission time of the DR transmission signal by N_midamble to form N_midamble DR transmission units. The D node may configure a midamble in each of the formed N_midamble DR transmission units (or after each DR transmission unit). The D node may not configure a midamble for the last DR transmission unit among the N_midamble DR transmission units. Accordingly, the D node may configure N_midamble−1 midambles in the DR transmission signal. The R node may transmit control information including information indicating whether to configure the last midamble to the D node through a PRDCH. The D node may receive, through the PRDCH, the control information including information indicating whether to configure the last midamble from the R node and may not configure the last midamble in the DR transmission signal according to the received control information.

For example, the D node may divide the total transmission time of the DR transmission signal by N_midamble+1 to form (N_midamble+1) DR transmission units. The D node may configure a midamble in each of the formed (N_midamble+1) DR transmission units (or after each DR transmission unit). The D node may configure the DR transmission signal such that no midamble is included after the last formed DR transmission unit.

For example, the D node may determine a transmission length (or transmission time) of Ref_N_Bit considering Ref_ChipDur as a basic unit, and may form DR transmission units by dividing the total transmission time of the DR transmission signal by each basic unit length or time. The D node may configure a midamble in each of the formed DR transmission units (or after each DR transmission unit).

In other words, the DR transmission units may be formed by dividing the total transmission time of the DR transmission signal by each basic unit length or time. The D node may configure a midamble in each of the formed DR transmission units. When Ref_ChipDur is not the maximum M chip duration, a chip duration scheduled for the DR transmission signal may be greater than Ref_ChipDur. In such a case, an information bit size transmitted per midamble may increase compared to Ref_N_Bit.

For example, the D node may determine a transmission length (or transmission time) of Ref_N_Bit considering Ref_ChipDur as a basic unit. The D node may form DR transmission units by dividing the total transmission time of the DR transmission signal by each basic unit length or time. The D node may configure a midamble in each of the formed DR transmission units.

The D node may form DR transmission units by dividing the total transmission time of the DR transmission signal by each basic unit length or time. The D node may configure a midamble in each of the formed DR transmission units, and may also configure a midamble at the end of the DR transmission signal. In other words, the D node may form DR transmission units by dividing the total transmission time of the DR transmission signal by each basic unit length or time. The D node may configure a midamble in each of the formed DR transmission units. The D node may configure a midamble in the last DR transmission unit even when the transmission time of the last DR transmission unit is shorter than the transmission time of the basic unit. When Ref_ChipDur is not the maximum M chip duration, a chip duration scheduled for DR transmission may be greater than Ref_ChipDur. In such a case, the information bit size transmitted per midamble may increase compared to Ref_N_Bit.

For example, the R node may define the reference information bit size Ref_N_Bit and/or reference chip duration Ref_ChipDur and/or reference channel code rate Ref_CR. Here, the reference chip duration Ref_ChipDur may be a maximum M value applicable to DR transmission, and the reference channel code rate Ref_CR may be 1/3. Alternatively, the reference information bit size Ref_N_Bit and/or reference chip duration Ref_ChipDur and/or reference channel code rate Ref_CR may be transmitted to the D node as being included in control information of the PRDCH. A transmission length (or transmission time) of Ref_N_Bit considering Ref_ChipDur and Ref_CR may be defined as a basic unit for configuring a midamble. The D node may calculate parameters related to midamble configuration.

For example, the R node may define the reference information bit size Ref_N_Bit. The R node may define the reference chip duration Ref_ChipDur. The reference chip duration may be, for example, a maximum M value applicable to the DR transmission signal. The R node may define the reference channel code rate Ref_CR. The reference channel code rate may be, for example, 1/3. The R node may transmit, through a PRDCH, control information including at least one of the reference information bit size, reference chip duration, or reference channel code rate to the D node. The D node may receive, through the PRDCH, control information including at least one of reference information bit size, reference chip duration, or reference channel code rate from the R node, and may store and manage the received information.

The D node may define a transmission length (or transmission time) of Ref_N_Bit considering Ref_ChipDur and Ref_CR as a basic unit for configuring a midamble. The D node may determine a basic number of midambles Cal_N_midamble related to midamble configuration using Equations 13 and 14 below.

$$Cal\_N \_midamble = [ N\_Bit \times ( Ref\_ChipDur / DR\_ChipDur ) \times R ] / [ Ref\_N \_Bit ] \qquad [ Equation 13 ]$$

$$Cal\_N \_midamble = [ N\_Bit \times ( Ref\_ChipDur / DR\_ChipDur ) ] / [ Ref\_N \_Bit ] \qquad [ Equation 14 ]$$

The R node may transmit a PDRCH including control information for PDRCH scheduling including at least one of information bit size, chip duration of a scheduled DR transmission signal, or DR repetition to the D node. The D node may receive, through the PDRCH, control information for PDRCH scheduling including at least one of information bit size, chip duration of the DR transmission signal, or DR repetition from the R node. The D node may determine the number of midambles N_midamble to be configured from Cal_N_midamble using Equations 15 to 17 below.

$$N\_midamble = floor ( Cal\_N \_midamble ) \qquad [ Equation 15 ]$$

$$N\_midamble = ceiling ( Cal\_N \_midamble ) \qquad [ Equation 16 ]$$

$$N\_midamble = int ( Cal\_N \_midamble ) \qquad [ Equation 17 ]$$

The D node may determine N_midamble as an integer value greater than Cal_N_midamble. The D node may determine N_midamble as an integer value smaller than Cal_N_midamble. The D node may configure midambles in the DR transmission signal in consideration of the determined N_midamble.

For example, the D node may divide the total transmission time of the DR transmission signal by N_midamble to form N_midamble DR transmission units. The D node may configure a midamble in each of the formed N_midamble DR transmission units (or after each DR transmission unit). The N_midamble DR transmission units may have the same transmission time. When the total transmission time of the DR transmission signal cannot be divided equally, the last DR transmission unit may have a transmission time different from other DR transmission units.

For example, the D node may divide the total transmission time of the DR transmission signal by N_midamble to form N_midamble DR transmission units. The D node may configure a midamble in each of the formed N_midamble DR transmission units (or after each DR transmission unit). The D node may not configure a midamble for the last DR transmission unit among the N_midamble DR transmission units. Accordingly, the D node may configure N_midamble−1 midambles in the DR transmission signal. The R node may transmit, through a PRDCH, control information including information indicating whether to configure the last midamble to the D node. The D node may receive, through the PRDCH, control information including information indicating whether to configure the last midamble from the R node, and may not configure the last midamble in the DR transmission signal according to the received control information.

For example, the D node may divide the total transmission time of the DR transmission signal by N_midamble+1 to form (N_midamble+1) DR transmission units. The D node may configure a midamble in each of the formed (N_midamble+1) DR transmission units (or after each DR transmission unit). The D node may configure the DR transmission signal such that no midamble is included after the last formed DR transmission unit.

For example, the D node may determine a transmission length (or transmission time) of Ref_N_Bit considering Ref_ChipDur as a basic unit, and may form DR transmission units by dividing the total transmission time of the DR transmission signal by each basic unit length or time. The D node may configure a midamble in each of the formed DR transmission units (or after each DR transmission unit).

In other words, the DR transmission units may be formed by dividing the total transmission time of the DR transmission signal by each basic unit length or time. The D node may configure a midamble in each of the formed DR transmission units. When Ref_ChipDur is not the maximum M chip duration, a chip duration scheduled for the DR transmission signal may be greater than Ref_ChipDur. In such a case, an information bit size transmitted per midamble may increase compared to Ref_N_Bit. In addition, when Ref_CR is not the minimum code rate, if a code rate scheduled for the DR transmission signal is greater than Ref_CR, an information bit size transmitted per midamble may increase compared to Ref_N_Bit.

For example, the D node may determine a transmission length (or transmission time) of Ref_N_Bit considering Ref_ChipDur as a basic unit. The D node may form DR transmission units by dividing the total transmission time of the DR transmission signal by each basic unit length or time. The D node may configure a midamble in each of the formed DR transmission units.

The D node may form DR transmission units by dividing the total transmission time of the DR transmission signal by each basic unit length or time. The D node may configure a midamble in each of the formed DR transmission units, and may also configure a midamble at the end of the DR transmission signal. In other words, the D node may form DR transmission units by dividing the total transmission time of the DR transmission signal by each basic unit length or time. The D node may configure a midamble in each of the formed DR transmission units. The D node may configure a midamble in the last DR transmission unit even when the transmission time of the last DR transmission unit is shorter than the transmission time of the basic unit. When Ref_ChipDur is not the maximum M chip duration, a chip duration scheduled for DR transmission may be greater than Ref_ChipDur. In such a case, an information bit size transmitted per midamble may increase compared to Ref_N_Bit. In addition, when Ref_CR is not the minimum code rate, if a code rate scheduled for the DR transmission signal is greater than Ref_CR, an information bit size transmitted per midamble may increase compared to Ref_N_Bit.

In the above examples, the control information transmitted as being included in the PRDCH may include information regarding whether to finally configure the N_midamble midamble(s). The R node may transmit, through the PRDCH, information regarding whether to finally configure the N_midamble midamble(s) to the D node. The D node may receive, through the PRDCH, information regarding whether to finally configure the N_midamble midamble(s) from the R node. The D node may determine whether to finally configure the midamble(s) according to the information on configuration included in the received control information.

The D node may determine a chip duration of an OOK symbol or BPSK symbol of the DR transmission signal based on control information included in the RD transmission signal and/or CAP. In a first exemplary embodiment, the R node may deliver to the D node RD control information including a chip duration of an OOK symbol or BPSK symbol of the DR transmission signal. The D node may receive, from the R node, RD control information including a chip duration of an OOK symbol or BPSK symbol of the DR transmission signal. The D node may determine the chip duration of an OOK symbol or BPSK symbol of the DR transmission signal based on the control information included in the RD transmission signal. As such, the R node may indicate, to the D node, information related to the chip duration of the OOK symbol or the BPSK symbol by including it in the RD control information.

In a second exemplary embodiment, the R node may deliver to the D node a CAP reflecting the chip duration of an OOK symbol or BPSK symbol of the DR transmission signal. The D node may receive, from the R node, the CAP reflecting the chip duration of an OOK symbol or BPSK symbol of the DR transmission signal. The D node may determine the chip duration of an OOK symbol or BPSK symbol of the DR transmission signal based on the CAP. For example, the D node may configure the chip duration of the PDRCH to be the same as a chip duration of a basic on/off pattern configured in the CAP of the RD transmission signal. As such, the R node may indicate, to the D node, the chip duration of an OOK symbol or BPSK symbol by reflecting it in the CAP.

In a third exemplary embodiment, the R node may indicate, to the D node, the chip duration of an OOK symbol or BPSK symbol through a combination of the CAP pattern and the RD control information. The D node may configure the chip duration of the PDRCH according to the chip duration of the OOK symbol or BPSK symbol indicated through the combination of the CAP pattern and the RD control information.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first communication node, comprising:
generating a first preamble including a first part indicating a start of a first signal and a second part for clock acquisition;
generating a physical reader-to-device channel (PRDCH) including data; and
transmitting, to a second communication node, the first signal including the first preamble and the PRDCH.

2. The method of claim 1, wherein the step of generating the PRDCH including the data comprises:
performing line encoding on the data; and
mapping a result of the line encoding to orthogonal frequency division multiplexing (OFDM) symbols to generate the PRDCH.

3. The method of claim 1, wherein the first part includes a first indicator having at least one first voltage signal and at least one second voltage signal in at least one OFDM symbol duration, and the first indicator indicates the start of the first signal.

4. The method of claim 1, wherein the second part comprises at least one first clock-acquisition signal having a first voltage level and at least one second clock-acquisition signal having a second voltage level, and the first clock-acquisition signal and the second clock-acquisition signal are alternately arranged.

5. The method of claim 1, wherein the PRDCH comprises at least one first PRDCH signal having a first voltage level and at least one second PRDCH signal having a second voltage level, and the second part includes an indication pattern for providing information on a first transmission time of the first PRDCH signal or information on a second transmission time of the second PRDCH signal.

6. The method of claim 5, wherein the indication pattern comprises at least one first clock-acquisition signal having the first voltage level and at least one second clock-acquisition signal having the second voltage level, and a third transmission time of the first clock-acquisition signal or a fourth transmission time of the second clock-acquisition signal is the same as the first transmission time or corresponds to the first transmission time.

7. The method of claim 5, wherein the indication pattern comprises a plurality of on-off keying (OOK) symbols, and an interval between rising edges or an interval between falling edges of the plurality of on-off keying symbols indicates the first transmission time or the second transmission time.

8. The method of claim 5, wherein the indication pattern is a base pattern formed of at least one first on-off keying (OOK) symbol and at least one second on-off keying (OOK) symbol, and a repetition count of the base pattern indicates the number of single-bit chips of the PRDCH.

9. The method of claim 5, wherein the second part includes a second indicator comprising at least one of a first on-off keying (OOK) symbol and a second on-off keying (OOK) symbol, and the second indicator indicates an end of the second part.

10. The method of claim 1, wherein the PRDCH further includes control information of a second signal, and the control information of the second signal comprises at least one of information on a period of a midamble or information on an additional midamble inserted into a last part of the second signal.

11. The method of claim 10, wherein the period is indicated in units of bits and is determined according to a chip duration of the second signal.

12. The method of claim 1, further comprising receiving, from the second communication node, the second signal formed based on control information of the second signal.

13. A method of a second communication node, comprising:
receiving, from a first communication node, a first signal including a preamble comprising a first part indicating a start of the first signal and a second part for clock acquisition, and a physical reader-to-device channel (PRDCH) providing control information and data of a second signal;
obtaining the control information and the data of the second signal from the PRDCH;
generating the second signal based on the control information of the second signal; and
transmitting the second signal to the first communication node.

14. The method of claim 13, wherein the second part includes at least one first clock acquisition signal having a first voltage level and at least one second clock acquisition signal having a second voltage level, wherein the PRDCH includes at least one first PRDCH signal having the first voltage level and at least one second PRDCH signal having the second voltage level, and wherein a first transmission time of the first clock acquisition signal or a second transmission time of the second clock acquisition signal is identical to a third transmission time of the first PRDCH signal or a fourth transmission time of the second PRDCH signal.

15. The method of claim 13, wherein the control information for the second signal includes information on a chip duration of the second signal, and the step of generating the second signal based on the control information of the second signal comprises:
determining the chip duration from the control information of the second signal; and
generating the second signal based on the chip duration.

16. The method of claim 14, wherein the control information of the second signal includes information on a chip duration of the second signal, and the generating of the second signal comprises:
determining the chip duration from the control information of the second signal; and
generating the second signal based on the chip duration.

17. The method of claim 16, wherein the period is indicated in units of bits, and a position of the midamble is determined according to the period and a chip duration of the second signal.

18. A first communication node comprising at least one processor, wherein the at least one processor causes the first communication node to perform:
generating a first preamble including a first part indicating a start of a first signal and a second part for clock acquisition;
generating a physical reader-to-device channel (PRDCH) including data; and
transmitting, to a second communication node, the first signal including the first preamble and the PRDCH.

19. The first communication node of claim 18, wherein in the generating of the PRDCH including data, the at least one processor causes the first communication node to perform:
performing line encoding on the data; and
mapping a result of the line encoding to orthogonal frequency division multiplexing (OFDM) symbols to generate the PRDCH.

20. The first communication node of claim 18, wherein the second part includes at least one first clock acquisition signal having a first voltage level and at least one second clock acquisition signal having a second voltage level, wherein the PRDCH includes at least one first PRDCH signal having the first voltage level and at least one second PRDCH signal having the second voltage level, and wherein a first transmission time of the first clock acquisition signal or a second transmission time of the second clock acquisition signal is identical to a third transmission time of the first PRDCH signal or a fourth transmission time of the second PRDCH signal.
